(19) United States
(12) Patent Application Publication
(10) Pub. No.: US 2022/0382332 A1
(43) Pub. Date: Dec. 1, 2022

(54) COVER FOR PORTABLE ELECTRONIC DEVICE

(71) Applicant: Vinci Brands LLC, Tustin, CA (US)

(72) Inventors: William Ho, Chino Hills, CA (US); Steven Corraliza, Oakland, CA (US); Hyun Hong, Los Angeles, CA (US)

(73) Assignee: Vinci Brands LLC, Tustin, CA (US)

(21) Appl. No.: 17/814,830

(22) Filed: Jul. 25, 2022

Related U.S. Application Data
(63) Continuation-in-part of application No. 17/655,173, filed on Mar. 16, 2022.
Application No. 17/655,173 is a continuation of application No. 17/453,836, filed on Nov. 5, 2021, now abandoned.
Application No. 17/453,836 is a continuation of application No. 17/242,282, filed on Apr. 27, 2021, now abandoned.
Application No. 17/242,282 is a continuation of application No. 16/186,371, filed on Nov. 9, 2018, now Pat. No. 10,990,134.

(51) Int. Cl. G06F 1/16; A45C 11/00; B29C 65/48; B29C 65/00

(52) U.S. Cl. CPC G06F 1/1656; A45C 11/00; B29C 65/4835; B29C 66/7292; B29C 66/0246; B29L 2031/768

(57) ABSTRACT

A light, durable, and user friendly cover for a laptop computer that integrates the protective qualities of hard shell cases with the aesthetics of soft cut-and-sew covers is disclosed herein. The cover includes top and bottom panels configured to cover the display and keyboard portions, respectively. Each panel is independent and separate from the other and each is formed as a unitary component of a molded resilient polymer material, such as polycarbonate, that is configured to reversibly and retentively snap-fit over the outer surface of the laptop computer. Each panel includes a raised lip along its perimeter edge region that defines an internally extending recessed region on the panel's outer surface. Fabric and/or leather overlays are positioned, sized, and adhesively coupled atop the recessed regions and are protected from delaminating, fraying, and/or peeling by the raised perimeter lip.

### CROSS-REFERENCE TO RELATED APPLICATIONS

This application is a continuation-in-part of U.S. Patent Application Serial No. 17/655,173, filed on Mar. 16, 2022, which is a continuation of U.S. patent application Ser. No. 17/453,836. filed on Nov. 5, 2021, which is a continuation of U.S. patent application Ser. No. 17/242,282, filed on Apr. 27, 2021, which is a continuation of U.S. patent application Ser. No. 16/186,371, filed on Nov. 9, 2018, the entireties of which are hereby incorporated herein by reference.

### BACKGROUND

The present disclosure generally relates to covers and cases for portable electronic devices, and particularly to fabric or leathered covered hard shell cases for computing devices such as laptop computers.

Portable electronic devices allow people to make and receive phone calls, send and receive e-mail, send and receive text messages, browse the Internet, play and record video, take and view pictures, play and record music, edit documents, and much more. These devices continue to revolutionize the way people interact, learn, connect with other people, conduct business, and find things. They help people manage their daily lives and can be a source of entertainment. These devices can be used to store valuable information including personal information (e.g., phone numbers, financial information, private photos or videos, and favorite music tracks).

Portable electronic devices, however, commonly include fragile components (e.g, screens, glass and/or aluminum or soft metal casings) that can be easily damaged and are manufactured with limited finishes that are not necessarily appealing to consumers in some or all environments or settings.

Various after-market hard and soft shell cases or covers have been developed to accessorize and protect portable electronic devices. Notwithstanding, there is a continued need to develop lightweight, user friendly protective cases, that uniquely meld the benefits of, and blur the lines between, soft and hard shell cases by providing aesthetically pleasing external surfaces found in cut-and-sew soft shell covers with the simplicity and durability of hard shell cases.

### SUMMARY

A cover for a portable electronic device that is light, durable, and user friendly is disclosed herein. The cover integrates the protective qualities of hard shell cases with the aesthetics of soft cut-and-sew covers. In some embodiments, a cover is configured for a laptop computer and includes top and bottom panels configured to cover the display and keyboard portions of the laptop computer. Each panel is independent and separate from the other and each is formed as a unitary component of a molded resilient polymer material, such as polycarbonate, that is configured to reversibly and retentively snap-fit over the outer surface of the laptop computer. Each panel includes a raised lip along its perimeter edge region that defines corresponding recessed regions on the panel's outer surface. Fabric and/or leather overlays arc positioned, size matched, and adhesively coupled atop the recessed regions and are protected from delaminating, fraying, and/or peeling by the raised perimeter lip. Various structures including internally positioned ventilation holes and support feet and corresponding footing platforms may be included and are configured to also protect the fabric/leather overlays from delaminating, fraying, and/or peeling.

While the illustrated embodiments of the cover are directed to a cover for a laptop computer having display and keyboard portions hinged together, the cover may be configured for different types of electronic devices, such as smartphones or tablets. In such configurations, the bottom and/or top cover may include an inner surface that is configured to reversibly and retentively snap-fit over the outer surface of the electronic device so that the electronic device screen and user interfaces are accessible.

Novel methods of manufacturing the top and bottom covers and components thereof are also disclosed herein. The methods are directed to preparation and sizing and cutting the fabric/leather overlays. forming the shell or panel components, positioning and adhesively coupling the overlay to the panels, and forming and securing support feet to the cover.

Other features and advantages of the disclosed covers and methods of construction will become apparent upon consideration of the following detailed description and the accompanying drawings.

### BRIEF DESCRIPTION OF THE DRAWINGS

FIGS. 1A-1F illustrate a top, bottom, front, rear, left, and right side views, respectively, of an exemplary exterior cover embodiment that includes a top cover configured to cover the display portion of a laptop computer and a bottom cover configured to cover the keyboard portion of a laptop computer. The illustrated cover is specifically configured to fit an Apple® 15-inch MacBook Pro® laptop computer, which is depicted in the cover, and is shown in a closed position. The dotted textured surfaces, illustrated in the drawings, depict fabric or leather overlays that are coupled to recessed regions, which are defined by a raised perimeter wall or lip, on the outer surface of flexible hard shell panels configured to receive and protect the overlays.

FIG. 2A is a top rear-right perspective view of the cover illustrated in FIGS. 1A-IF.

FIG. 2B is a top front-left perspective view of the cover illustrated in FIGS. 1A-1F.

FIG. 2C is a bottom rear-right perspective view of the cover illustrated in FIGS. 1A-1F.

FIG. 2D is a bottom front-left perspective view of the cover illustrated in FIGS. 1A-IF.

FIG. 3A is a top rear-left perspective view of the cover illustrated in FIGS. 1A-IF with the laptop display portion in an open position.

FIG. 3B is a bottom front-right perspective view of the cover illustrated in FIGS. 1A-IF with the laptop display portion in an open position.

FIG. 4A is an exterior view of the top cover component of the laptop cover illustrated in FIGS. 1A-IF, with the fabric/leather overlay removed to reveal the outer surface of the top cover panel,

FIG. 4B is an interior view of the display cover illustrated in FIG. 4A with the display portion of the laptop computer removed to reveal the inner surface of the top cover panel. DT1 and DT2 define the length and width of the display compartment defined by the inner surface of the top cover panel.

FIG. 6A is an exterior rear-right perspective view of the top cover panel illustrated in FIGS. 4A-4B.

FIGS. 6B-6D are enlarged perspective views of the corresponding enumerated areas of the top cover panel circled in FIG. 5A to further illustrate the curvature of the outer surface of the panel and the recessed region defined by the raised perimeter wall.

FIG. 6A is an exterior front-right perspective view of the top cover panel illustrated in FIGS. 4A-4B.

FIGS. 6B-6D are enlarged perspective views of the corresponding enumerated areas of the top cover panel circled in FIG. 6A to further illustrate the curvature of the outer surface of the panel and the recessed region defined by the raised perimeter wall.

FIG. 7A is an interior rear-right perspective view of the top cover panel illustrated in FIGS. 4A-4B.

FIGS. 7B-7G are enlarged perspective views of the corresponding enumerated areas of the top cover panel circled in FIG. 7A to further illustrate the inner surface of the panel including the compartment defined thereby, the raised perimeter walls, and the retention tabs extending inwardly from the inner surface of the panel.

FIG. 8A is a duplicate of FIG. 4B with cross-sectional reference lines added.

FIGS. 8B, 8D, 8F, 8F, 8H, and 8K are cross-sectional views taken along corresponding enumerated cross reference lines 8B-8B, 8D-8D, 8F-8F, 8H-8H, and 8K-8K of the top cover panel as illustrated in FIG. 8A.

FIGS. 8C, 8E, 8G, 8I, 8J, and 8L are enlarged perspective views of corresponding enumerated areas of the cross-sectional views of the top cover panel encircled in FIGS. 88, 8D, 8F, 8H, and 8K, respectively. For reference, the fabric/leather layer is shown in phantom/broken lines.

FIG. 9A is an exterior view of the bottom cover component of the laptop cover illustrated in FIGS. 0.1A-IF, with the support feet and the fabric/leather overlay removed to reveal the outer surface of the bottom cover panel and the foot attachment holes.

FIG. 9B is an interior view of the display cover illustrated in FIG. 9A with the keyboard portion of the laptop computer removed to reveal the inner surface of the bottom cover panel. DB1-DB6 define the various lengths and widths of the keyboard compartment and the position of the footing platforms defined by the inner surface of the bottom cover panel.

FIGS. 9C-9F are the front, rear, left, and right views, respectively, of the bottom cover panel illustrated in FIG. 9A.

FIG. 10A is an interior rear-right perspective view of the top cover panel illustrated in FIGS. 9A-9F.

FIGS. 10B-10E are enlarged perspective views of the corresponding enumerated areas of the bottom cover panel circled in FIG. 10A to further illustrate the curvature of the surfaces of the panel, the keyboard compartment defined therein, the retention tabs, and the raised perimeter wall that defines the recessed region on the outer surface of the panel.

FIG. 11A is an exterior front-left perspective view of the bottom cover panel illustrated in FIGS. 9A-9F.

FIGS. 11B-11E are enlarged perspective views of the corresponding enumerated areas of the bottom cover panel circled in FIG. 11A to further illustrate the curvature of the outer surface of the panel, the footing platforms, ventilation and access apertures, and the recessed region defined by the raised perimeter wall.

FIG. 12A is an exterior rear-right perspective view of the bottom cover panel illustrated in FIGS. 9A-9F.

FIGS. 128-12E are enlarged perspective views of the corresponding enumerated areas of the bottom cover panel circled in FIG. 12A to further illustrate the outer surface of the panel, including the outwardly protruding footing platforms, the recessed regions defining the raised perimeter walls, and the outwardly protruding ventilation aperture walls.

FIG. 13A is a duplicate of FIG. 98 with cross-sectional reference lines added.

FIGS. 138, 13D, 13F, 1311, 13J, and 13M arc cross-sectional views taken along corresponding enumerated cross reference lines 13B-13B, 13D-13D. 13F-13F. 13H-1311, 13J-13J, and 13M-13M of the bottom cover panel as illustrated in FIG. 13A.

FIGS. 13C, 13E, 13G, 13I, 13K, 13L, 13N, and 13P are enlarged perspective views of corresponding enumerated areas of the cross-sectional views of the top cover panel encircled in.

FIGS. 13B, 13D, 13F, 13H, 133, and 13K, respectively. For reference, the fabric/leather layer is shown in phantom/broken lines.

FIG. 14A is a flow diagram of an exemplary manufacturing process for making the top cover, where the top cover is configured to cover the display portion of a laptop computer.

FIG. 14B is a flow diagram of an exemplary manufacturing process for making the bottom cover, where the bottom cover is configured to cover the keyboard portion of a laptop computer.

FIG. 15 is a perspective view of a support foot separated from the cover, illustrating the internal and external portions thereof.

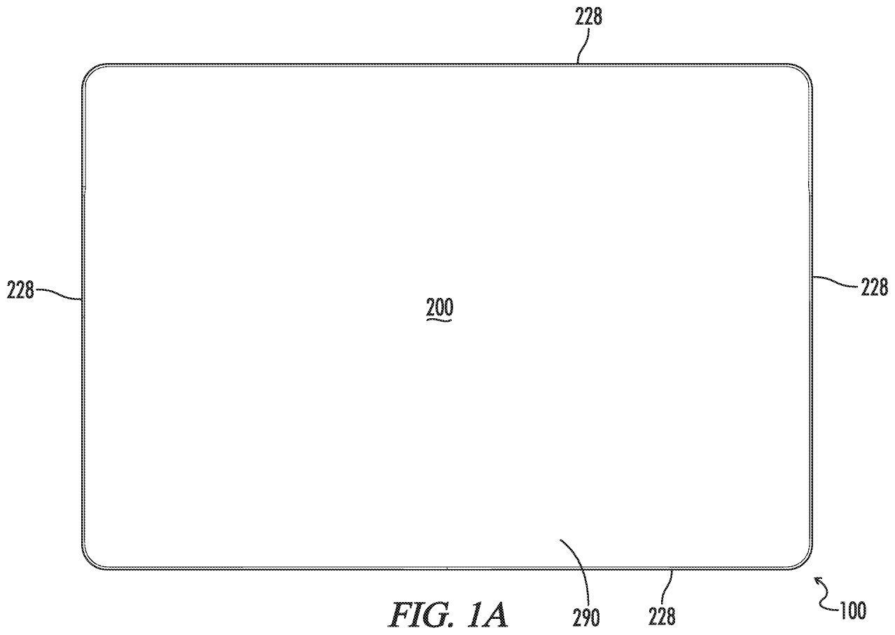

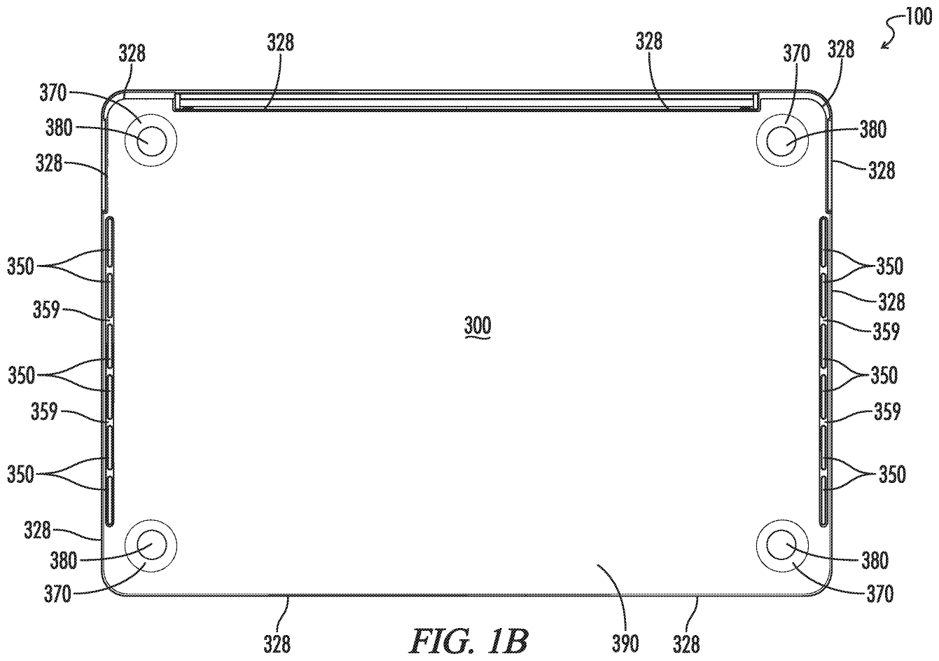

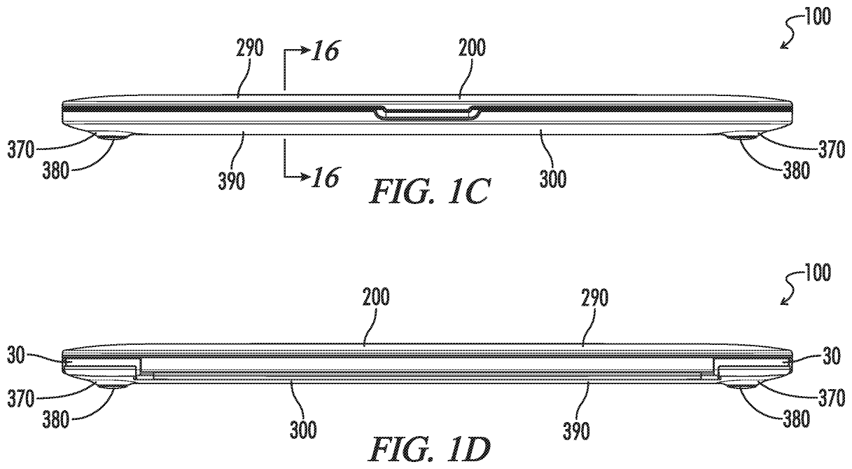

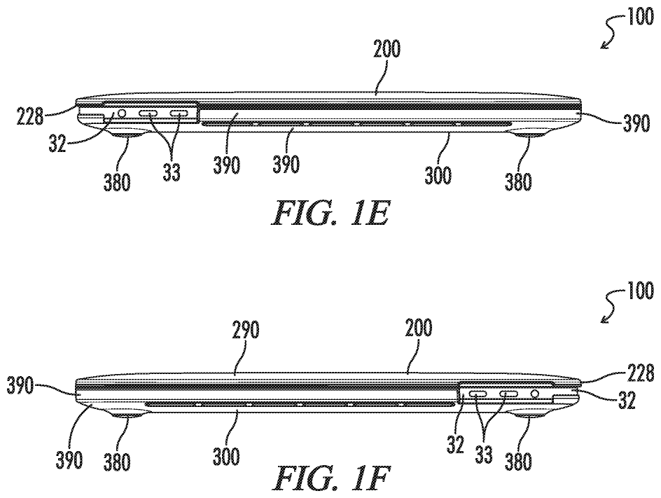

FIG. 16 is an enlarged partial cross-sectional view taken along line 16-16 in FIG. 1C illustrating the internal contour of the cover relative to the laptop computer including the hinge portion thereof.

### DETAILED DESCRIPTION

The present disclosure generally relates to a cover for a portable electronic device that is light, durable, and user friendly. The cover integrates the protective qualities of hard shell cases with the aesthetics of soft cut-and-sew covers. In some embodiments, a cover is configured for a laptop computer and includes top and bottom panels configured to cover the display and keyboard portions of the laptop computer. Each panel is independent and separate from the other and each is formed as a unitary component of a molded resilient polymer material, such as polycarbonate, that is configured to reversibly and retentively snap-fit over the outer surface of the laptop computer. Each panel includes a raised lip along its perimeter edge region that defines corresponding recessed regions on the panel's outer surface. Fabric and/or leather overlays are positioned, size matched, and adhesively coupled atop the recessed regions and are protected from delaminating, fraying, and/or peeling by the raised perimeter lip. Various structures including internally positioned ventilation holes and support feet and corresponding footing platforms may be included and are configured to also protect the fabric/leather overlays from delaminating, fraying, and/or peeling.

It should be understood that the embodiments illustrated and described herein are examples and are not intended to be limiting. In the drawings, like reference numerals refer to like parts throughout, which include:
laptop computer 10
display portion 20
inner surface 21
outer surface 22
keyboard portion 30
inner surface 31
outer surface 32
user interfaces (e.g.. ports, jacks, etc.) 33
exterior covet 100
top cover 200
top cover panel 220
outer surface 221
inner surface 222
display portion compartment 225
retention tabs 227
perimeter edge region 223
raised perimeter lip 228
raised surface 229
proximate side 230
opposing outer side 231
recessed region 240
fabric/leather overlay 290
bottom cover 300
bottom cover panel 320
outer surface 321
inner surface 322
keyboard portion compartment 325
retention tabs 327
internally extending curved retention lip 326
perimeter edge region 323
raised perimeter lip 328
raised surface 329
proximate side 330
opposing outer side 331
recessed region 340
ventilation apertures 350
outwardly protruding ventilation aperture walls 355
raised ventilation aperture wall surface 359
proximate side 360
opposing internal side 361
outwardly protruding footing platforms 370
opposing recessed regions 371
foot attachment holes 372
support foot 380
internal portion 381
external portion 382
fabric/leather overlay 390

Described and illustrated herein is a portable electronic device cover that is lightweight, durable, and user friendly while also blurring the lines between soft and hard shell cases by combining aesthetically pleasing surfaces found in cut-and-sew soft shell covers with the simplicity and durability of hard shell cases.

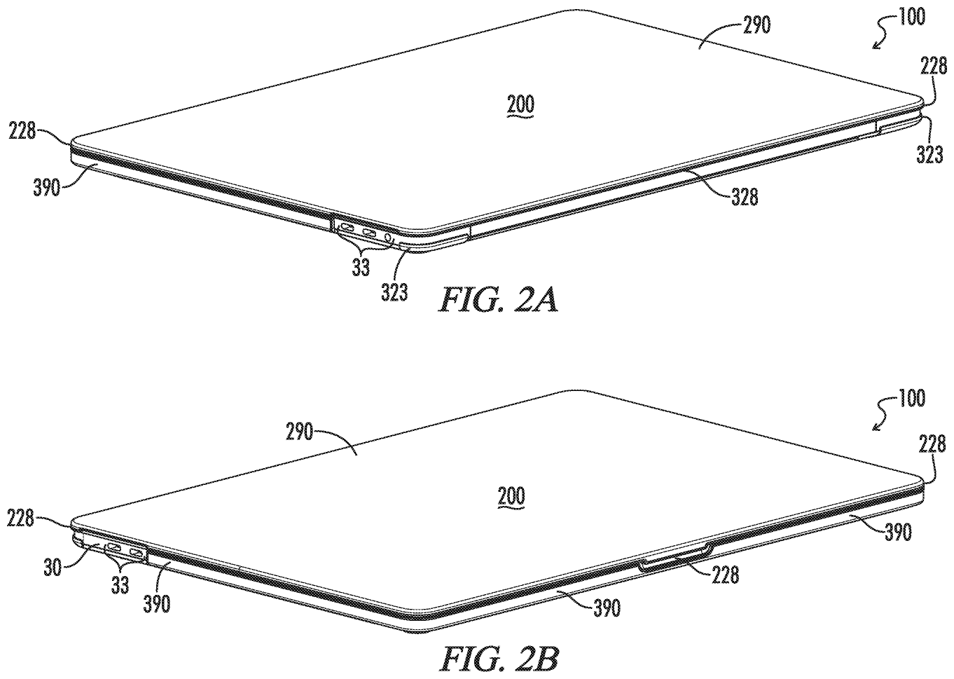

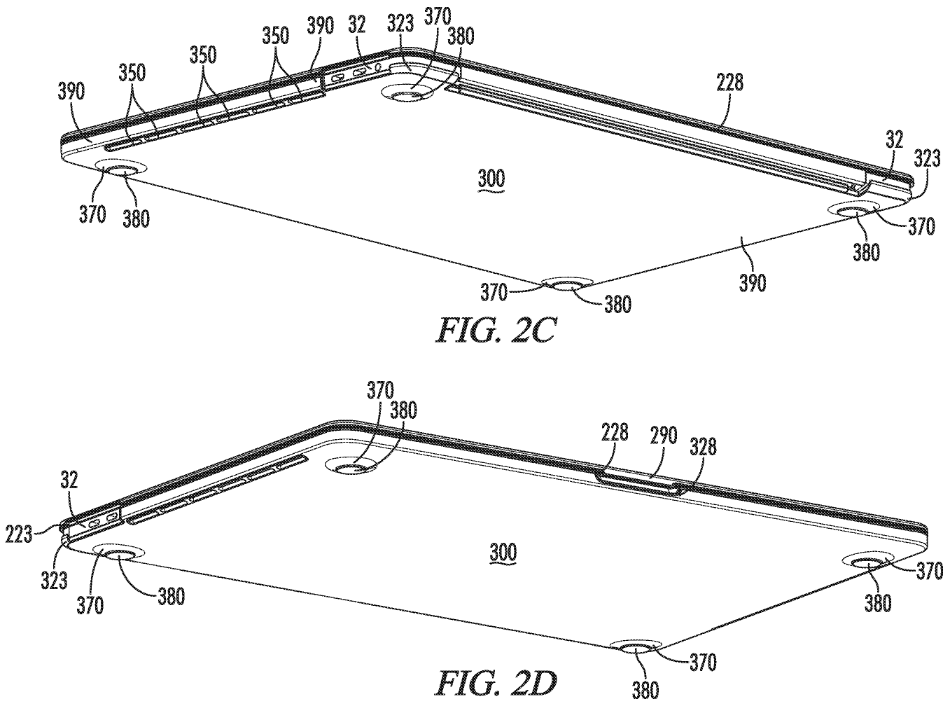

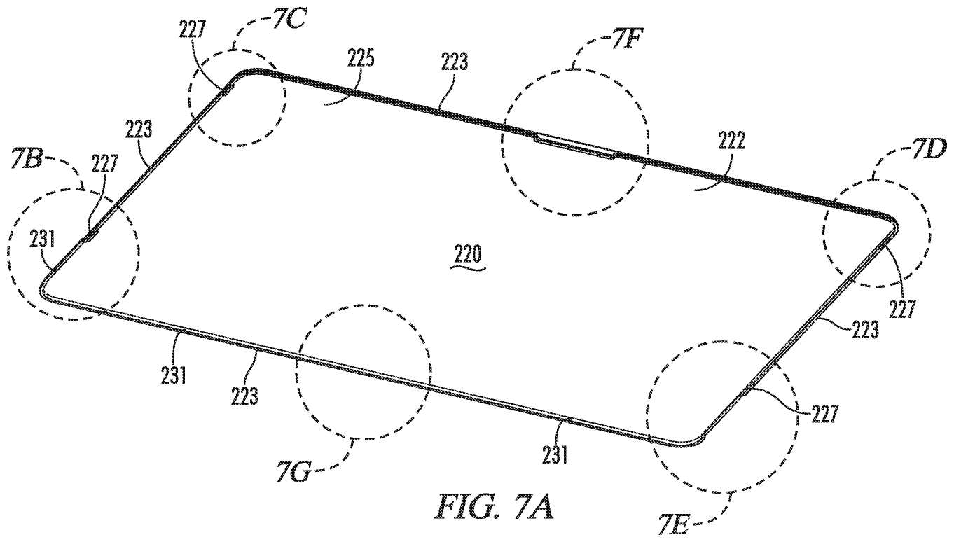

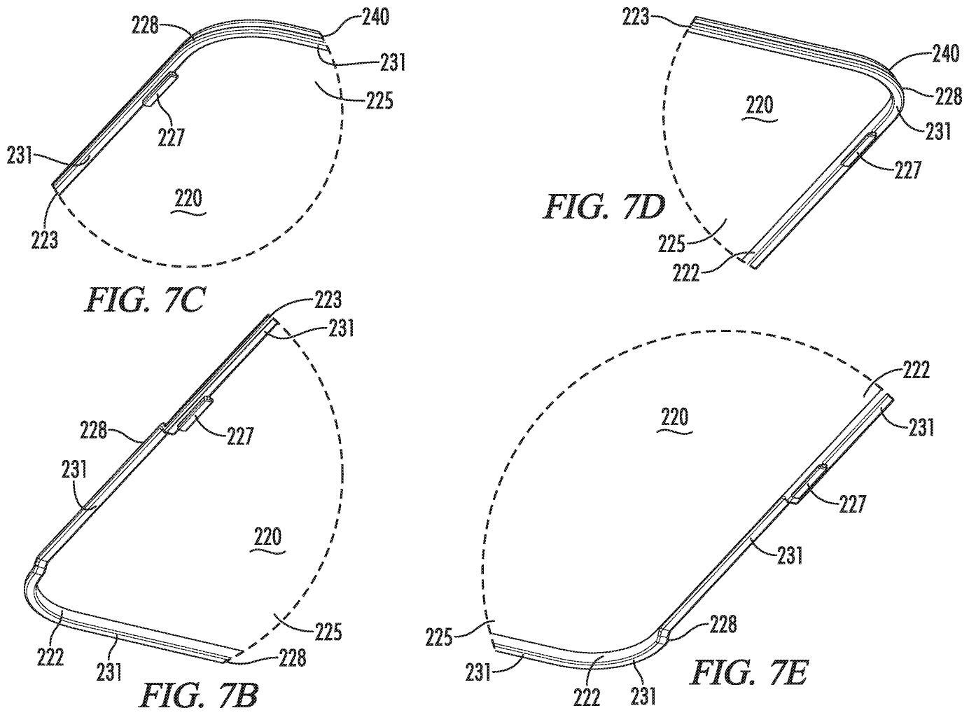

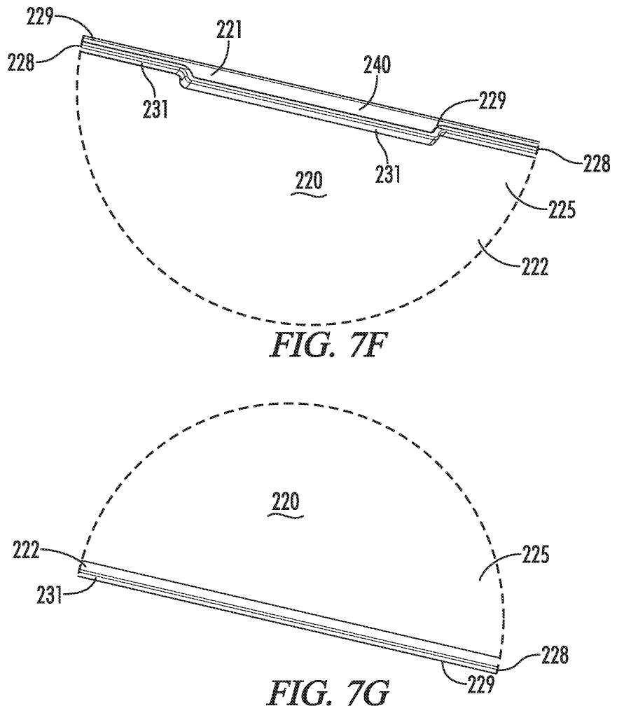

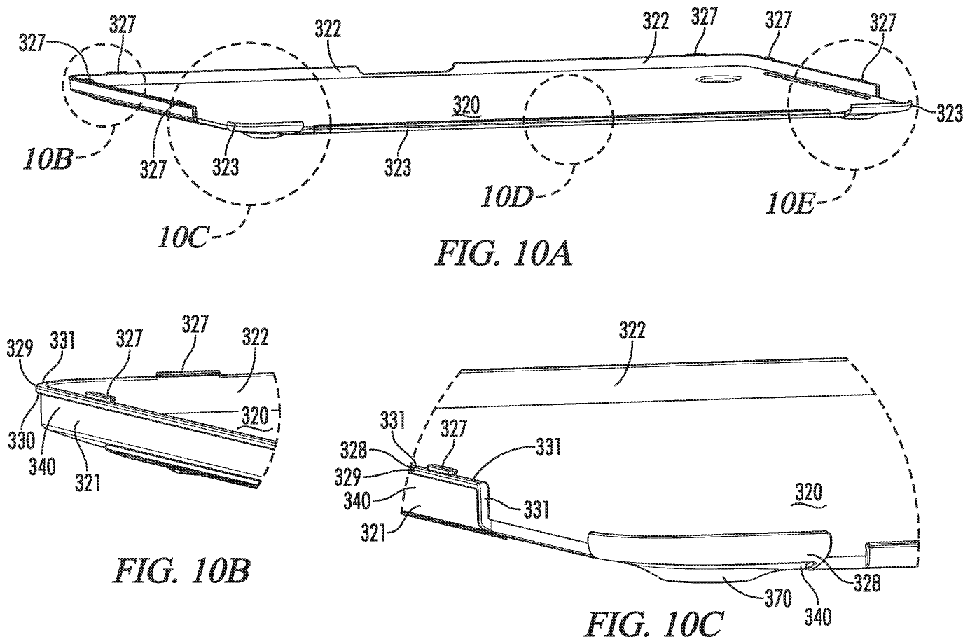

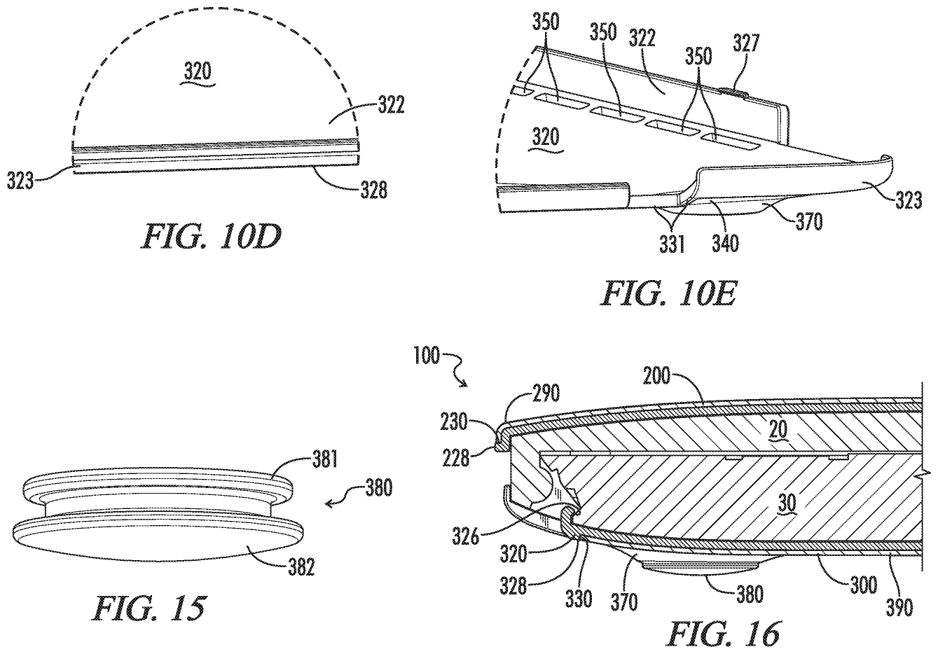

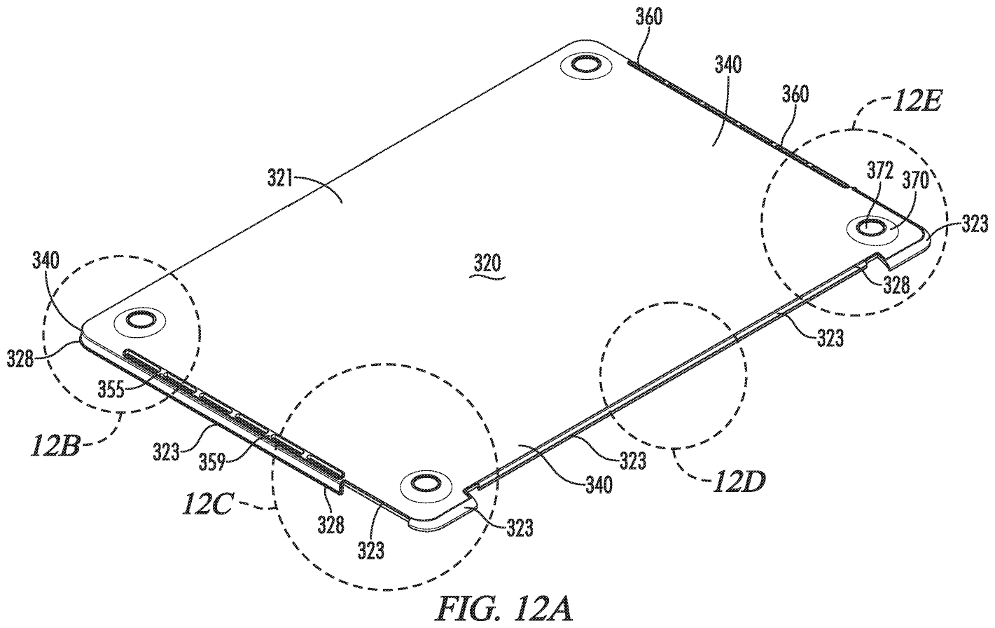

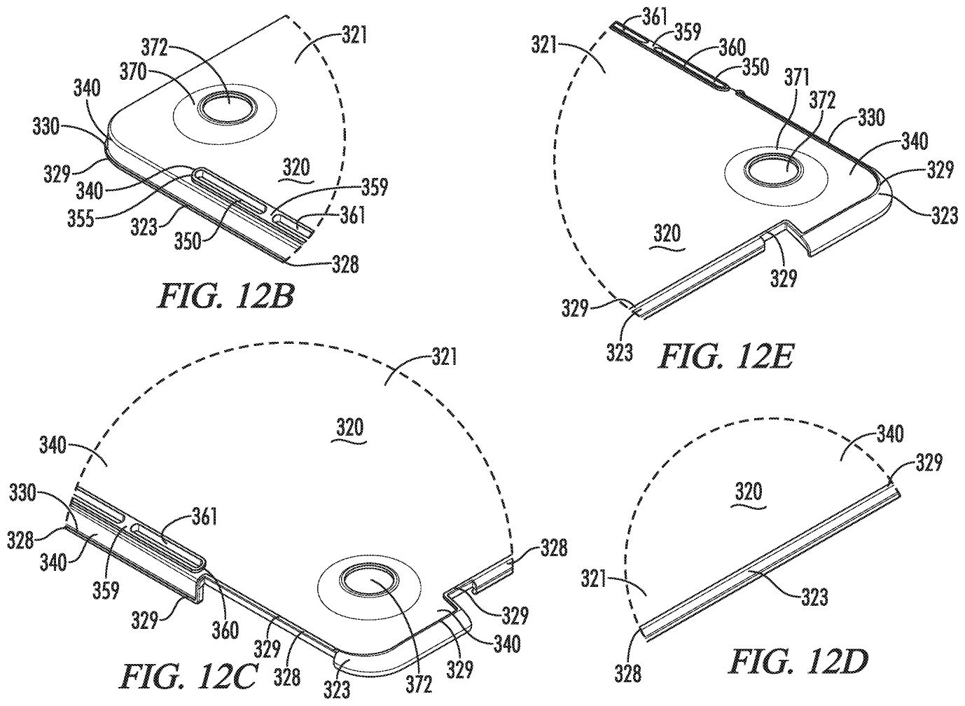

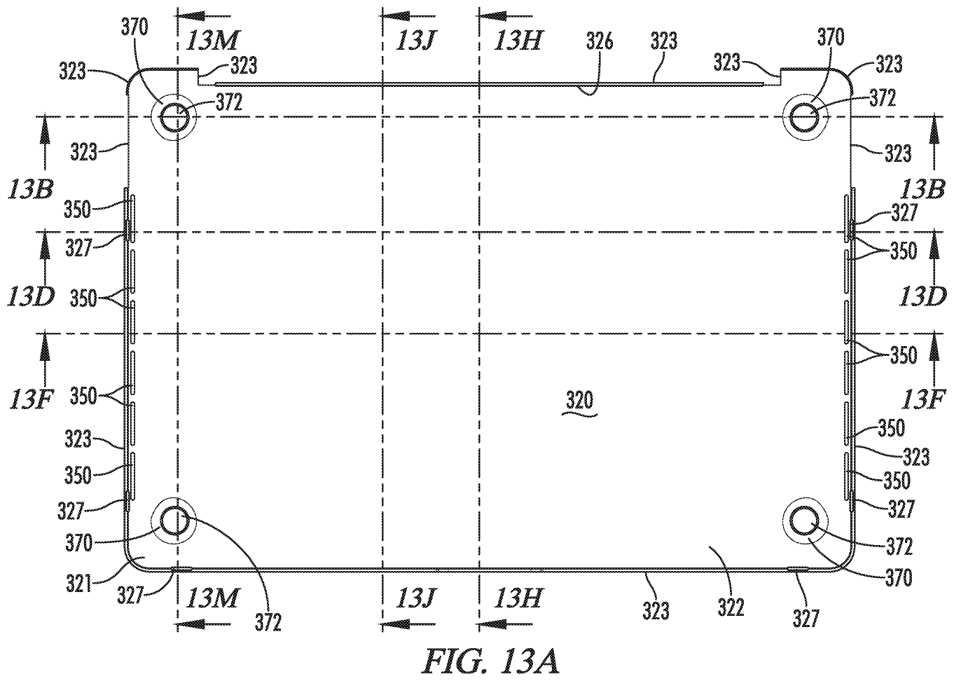

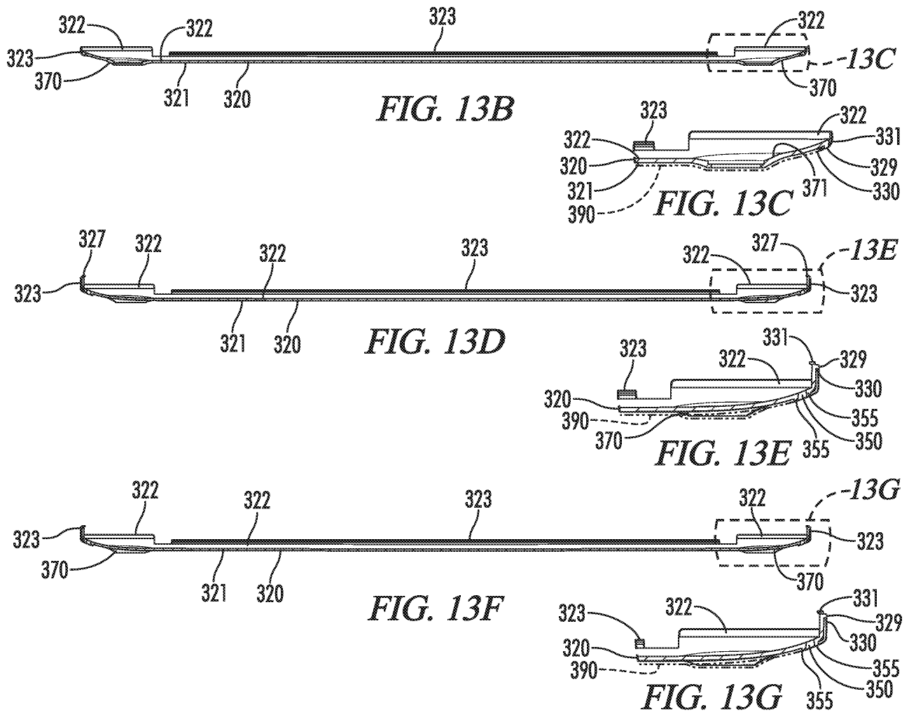

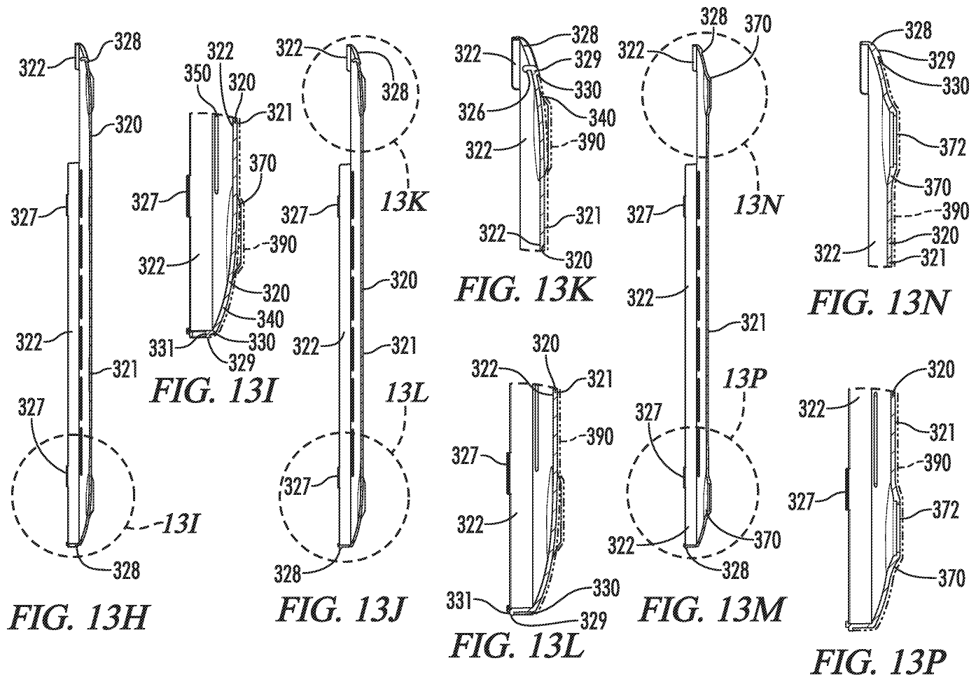

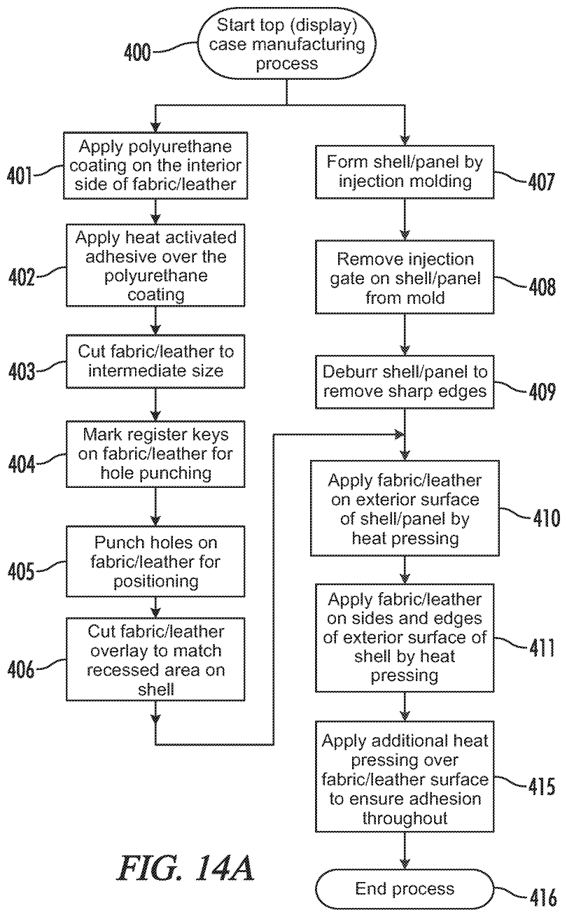

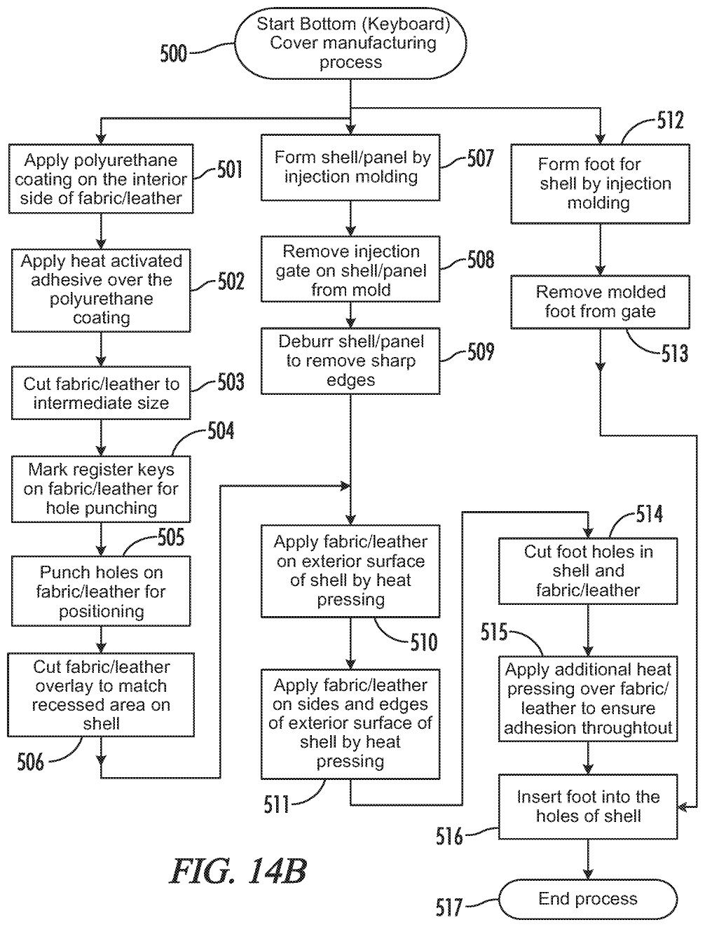

As set forth above, FIGS. 1A-16 illustrate various aspects of an exterior cover 100 formed and dimensioned to reversibly and retentively receive and protect a laptop computer 10 having a display portion 20 and a keyboard portion 30 (best illustrated in FIGS. 1-3). The display portion 20 and keyboard portion are each externally defined by inner and outer surfaces 21, 22. 31, and 32 respectively, such that the inner surfaces 21 and 31 include the display screen on the display portion 20 and the keyboard interface face on the keyboard portion 30 such that when the laptop 10 is in the closed position the two inner surfaces 21 and 31 are opposed and directly face each other as best illustrated in FIGS. 1-3 and 16. As best illustrated in the side views of FIGS. 1E-3B the keyboard portion for the particular laptop illustrated (Apple® 15-inch MacBook Pro® laptop computer) includes various user interfaces 33 on its right and left sides. Such user interfaces may be ports, jacks, speakers, microphones, or other electrical, mechanical, optical, and/or acoustic connectors or interfaces. It should be understood that other laptop models may have user interfaces on the display portion 20 and in other regions or sides. It should be understood that the cover 100 is configured to correspond to the outer shape and user interfaces of the particular electronic device for which it is adapted for use.

The cover 100 includes a top cover 200 and a bottom cover 300. The top cover 200 includes a top cover or first panel 220 that is configured to cover the outer surface 22 of the display portion 20 and the bottom cover 300 includes a bottom cover or second panel 320 configured to cover the outer surface 32 of the keyboard portion 30. Each of said panels 220 and 320 are independent and separate from one another and each panel is formed as a unitary component of a molded resilient polymer material dimensioned to reversibly and retentively snap-fit over the display portion 20 and keyboard portion 30, respectively. Thus, the cover 100 includes snap-fit designs that are configured for multiple uses, such that the user can attach and remove the cover 100 from the electronic device multiple times while retaining functionality of the cover 100.

The top panel 220 includes a large generally planar wall that is configured to cover and protect the back face of the display portion 20 and multiple side walls that extend generally perpendicular to the generally planar wall that are configured to cover and protect the sides of the display portion 10. Similarly, the bottom panel 320 includes a large generally planar wall that is configured to cover and protect the back face of the keyboard portion 30 and multiple side walls that extend generally perpendicular thereto that are con figured to cover and protect the sides of the keyboard portion 30.

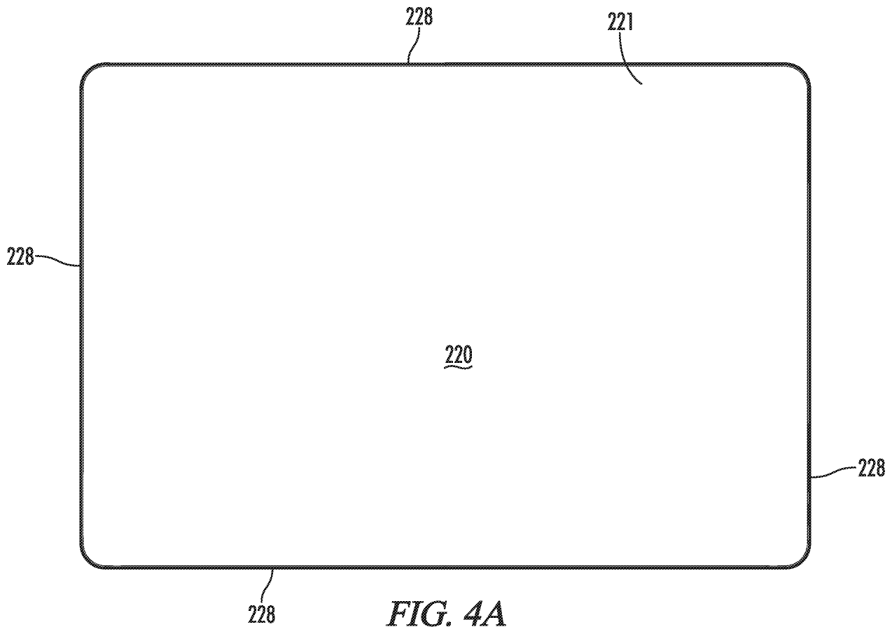

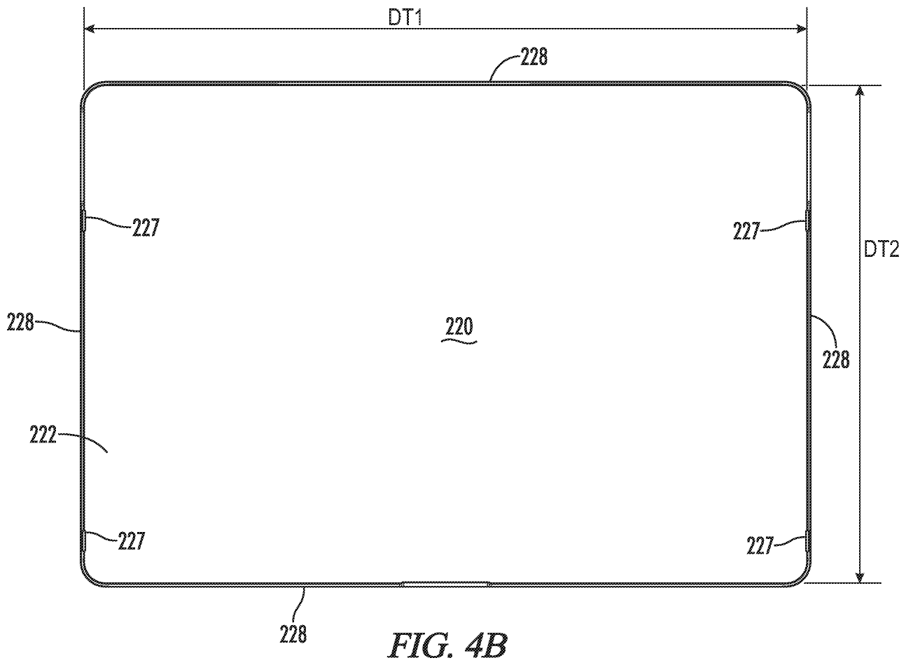

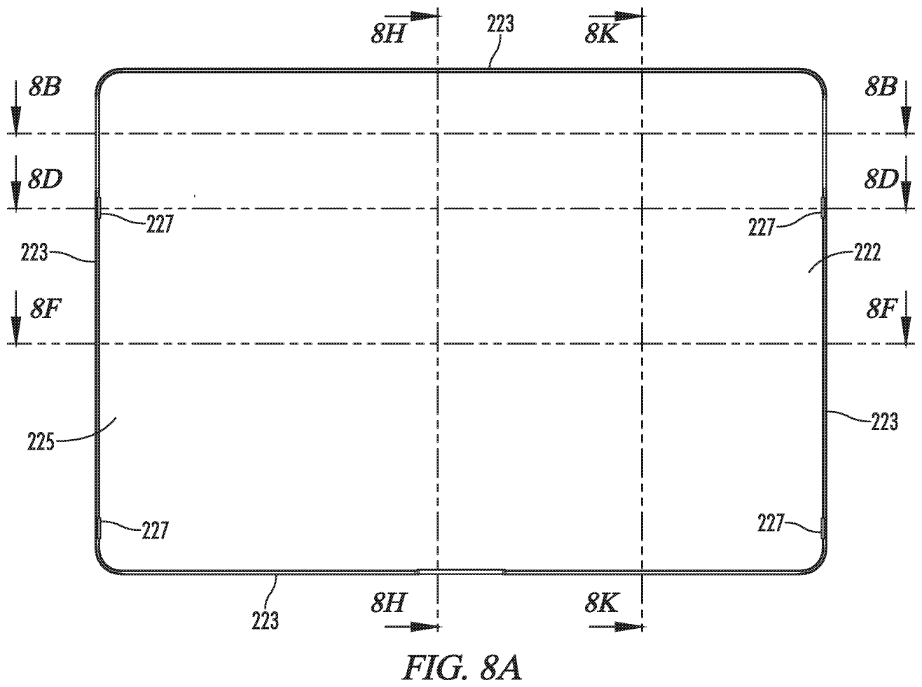

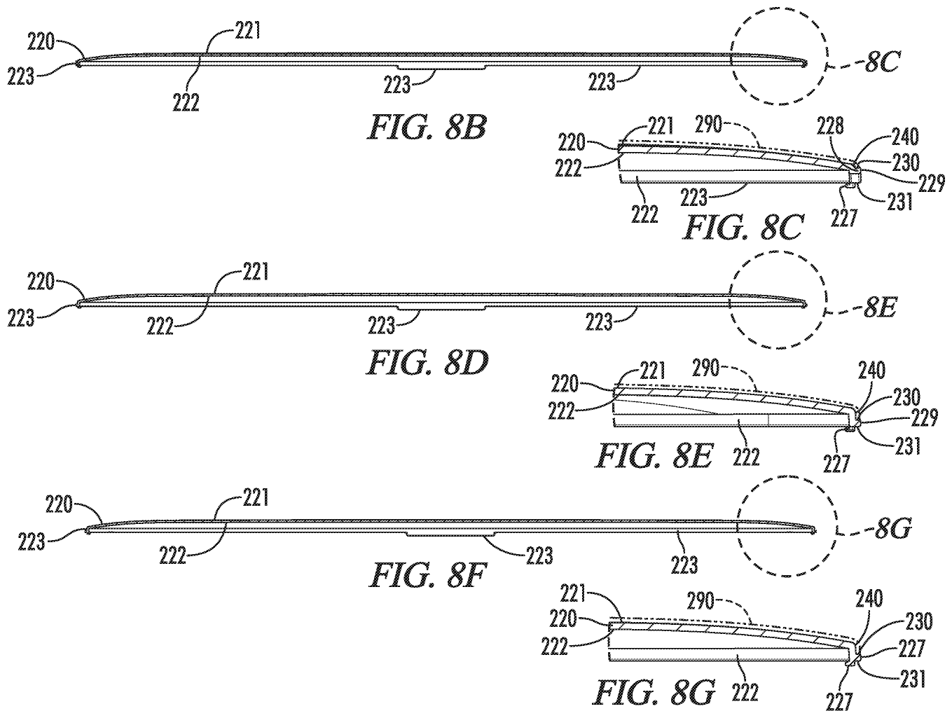

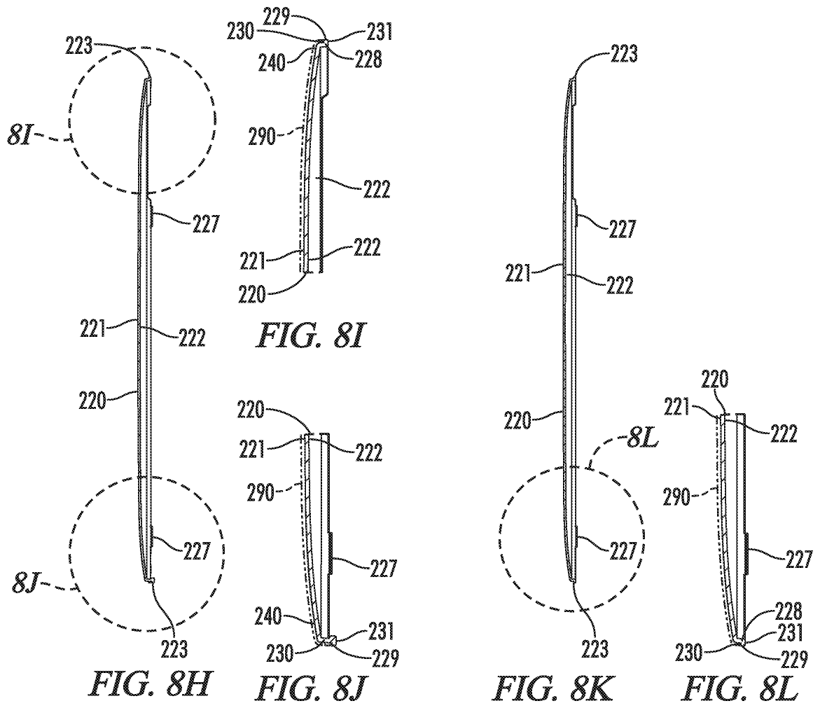

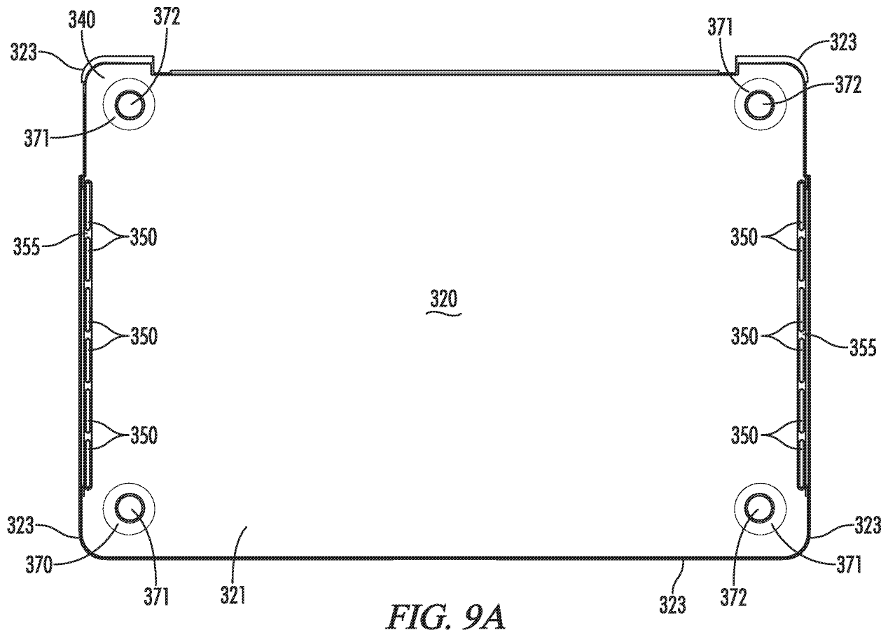

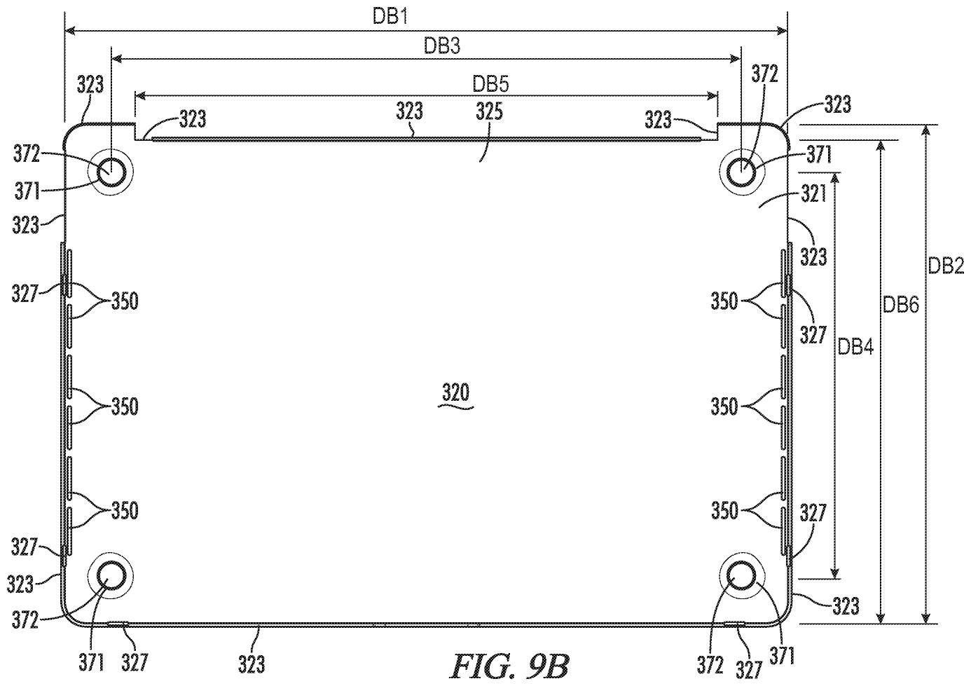

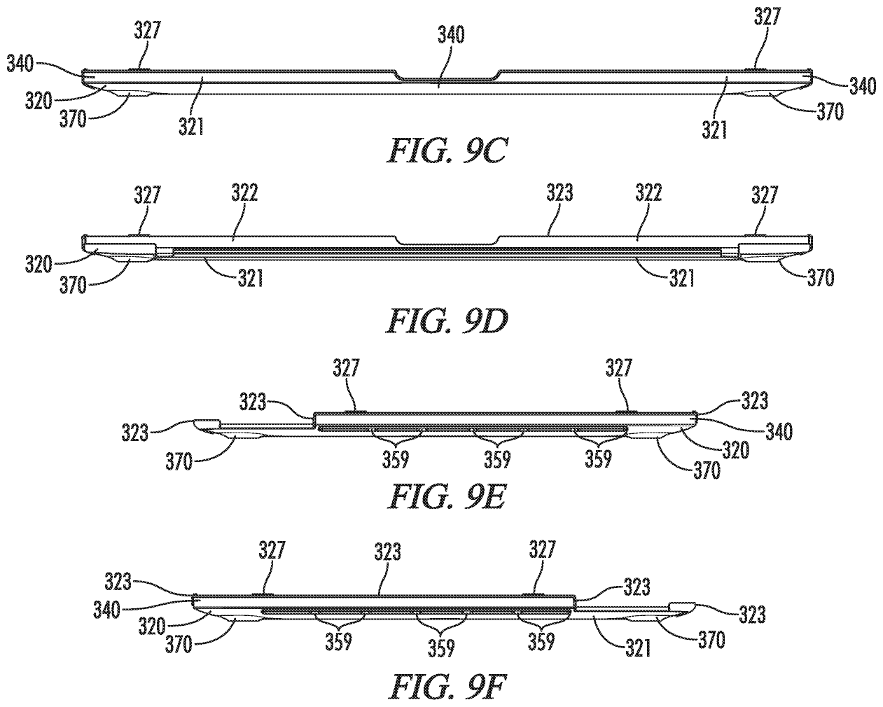

The top panel 220, which is illustrated as a stand-alone component in FIGS. 4A, 8L, is defined by inner and opposing outer surfaces 222 and 221, respectively, that are separated by a perimeter edge region 223. The inner surface 222 of the top panel 220 defines a compartment 225 dimensioned to receive and cover the outer surface 22 of the display portion 20 of the laptop computer 10. The bottom panel 320, which is illustrated as a stand-alone component in FIGS. 9A-13P, is also defined by inner and opposing outer surfaces 322 and 321, respectively, that are separated by a perimeter edge region 323. The inner surface 322 of the top panel 320 defines a compartment 325 dimensioned to receive and cover the outer surface 32 of the keyboard portion 30 of the laptop computer 10.

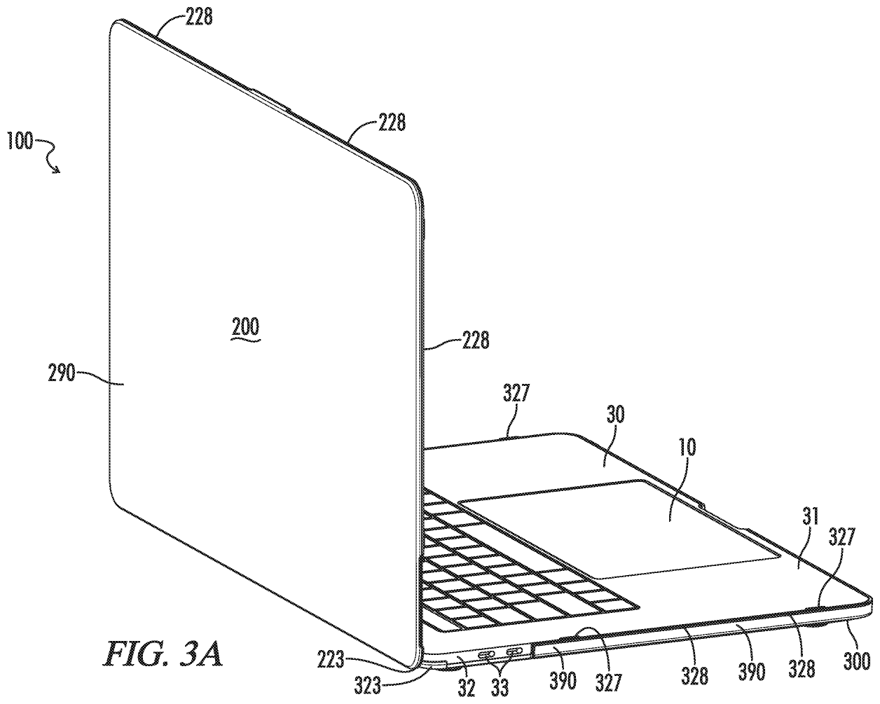

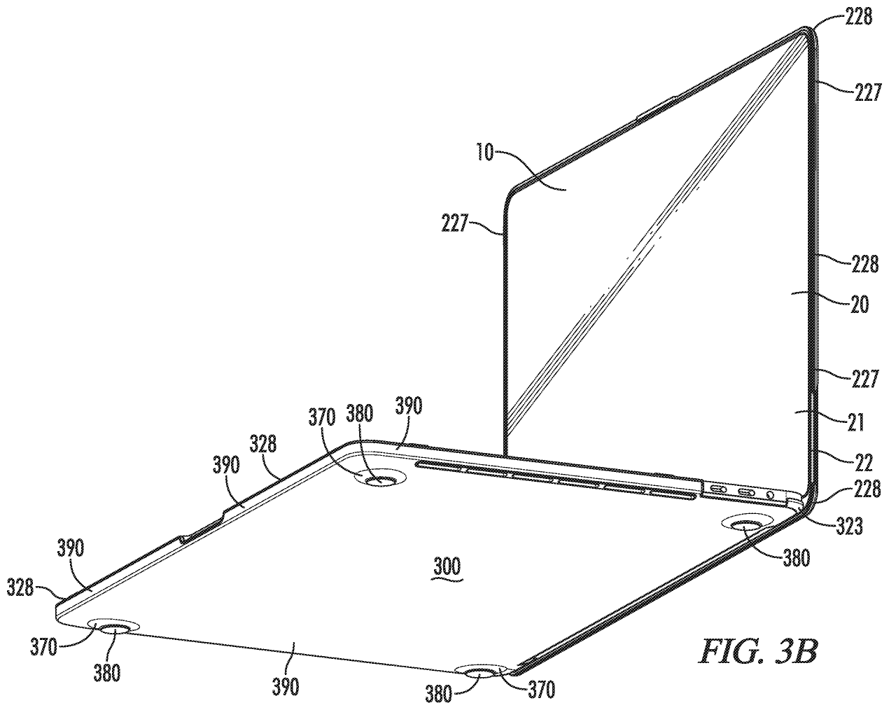

Each of the top and bottom panels 220 and 320 include a first plurality of retention tabs 227 and 327 located at their respective perimeter edge regions 223 and 323 that extend inwardly from the their respective inner surfaces 222 and 322 in a transverse direction therefrom. The retention tabs 227 and 327 are dimensioned to engage the corresponding inner surfaces 21 and 31 of the display and keyboard portions 20 and 30 of the laptop computer 10 when attached thereto. FIGS. 3A-33 illustrate the retention tabs 227 and 327 in place over the inner surfaces 21 and 31 of the display and keyboard portions 20 and 30 of the laptop computer 10. As best illustrated in FIG. 4B, the top panel 220 includes two pairs of retention tabs 227, with one pair extending from the right side wall and another pair extending from left side wall of the top panel 220. In contrast, the bottom panel 320, as best illustrated in FIG. 9B, is configured to include three pairs of retention tabs 327, with a pair of retention tabs extending from each of the right, left, and front side walls of the bottom panel 320. When the laptop computer 10 is in a closed position, the retention tabs 227 on the left and right side walls of the top panel 220 and the retention tabs 327 on the left and right side walls of the bottom panel 320 are configured to offset to each other and are dimensioned to extend in limited length so that when the laptop computer 10 is closed the retention tabs 227 and 327 do not affect the adaptation between the display and keyboard portions 20 and 30. In addition, as best illustrated in FIG. 13K and FIG. 16, the internally facing perimeter edge region 323 that extends along the recessed back side wall of the bottom panel 320 includes an internally extending curved retention lip 326 that is configured to snap over a corresponding recessed region of the hinge of the laptop computer 10 to maintain the keyboard portion 30 within the keyboard compartment 325 and keep the keyboard from sliding out of the back side of the bottom cover 300. The curved retention lip 326 is positioned below the retention tabs 327 to allow the user to more easily insert the keyboard from the back side of the bottom cover 300 and snap fit the keyboard portion 30 into the keyboard compartment 325 of the bottom cover panel 320 without tearing the cover panel 320 or damaging the keyboard. Similarly, including retention tabs on two opposing sides of the top panel 220 also allows the user to more easily insert and snap fit the top panel compartment 225 over the display portion 20 without tearing the top panel 220 or damaging the display.

In alternate embodiments, other retention tab configurations are also contemplated. For example, additional or fewer retention tabs may be included, the retention tabs may be extend from different walls and may be of larger or smaller size, etc.

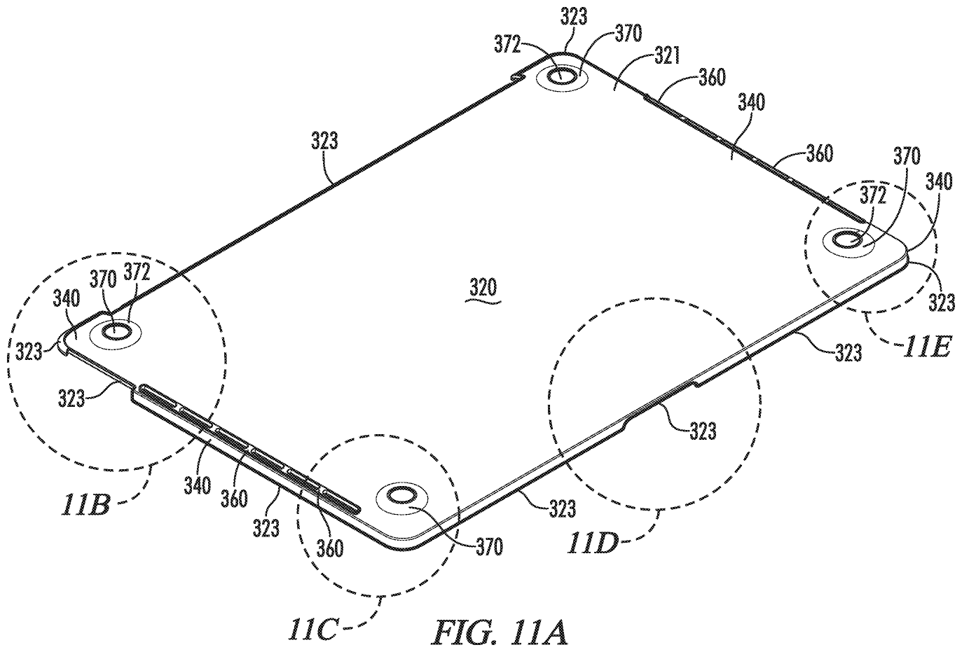

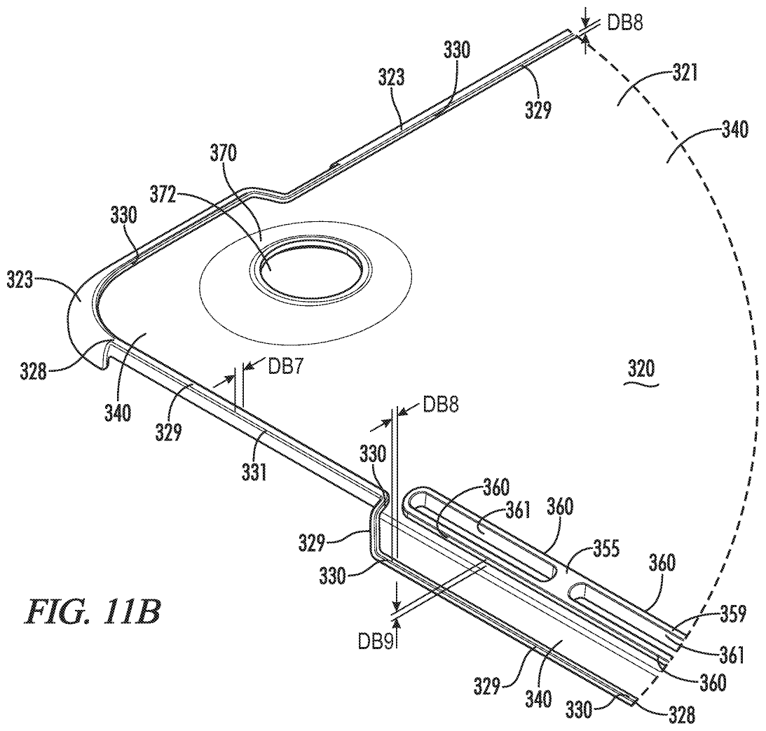

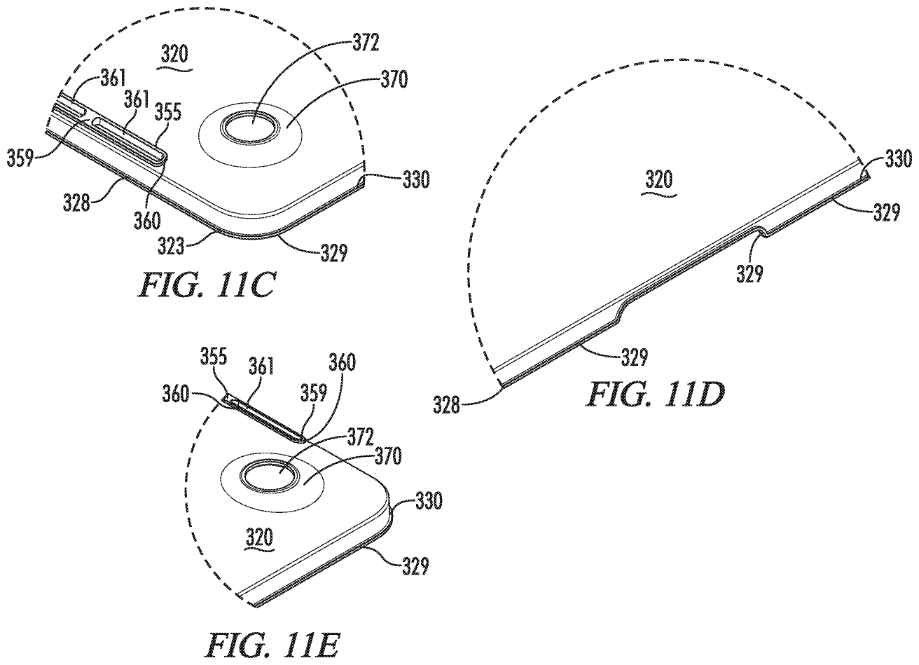

Each of the top and bottom panels 220 and 320 include a raised perimeter wall or lip 228 and 328, respectively, that extends longitudinally along the entirety of their respective perimeter edge regions 223 and 323 and projects outwardly from their respective outer surfaces 221 and 321 to define corresponding raised surfaces 229 and 329. Each of the raised perimeter lips 228 and 328 are defined by a proximate side 230 and 330 and opposing outer sides 231 and 331, respectively. The proximate side 230 that defines the lip 228 on the top panel 220 defines a border that encircles a recessed region 240 formed on the outer surface 221 of the top panel 220. As measured on the proximate side 230 from the recessed region 240 extending outwardly from the base thereof to the raised surface 229, the lip 228 has a height defined by a first dimension, which, as representatively illustrated in FIG. 613, is referred to as DT8. Similarly, the proximate side 330 that defines the lip 328 on the bottom panel 320 defines a border that encircles a recessed region 340 formed on the outer surface 321 of the bottom panel 320. As measured on the proximate side 330 from the recessed region 340 extending outwardly from the base thereof to the raised surface 329, the lip 328 has a height defined by a second dimension, which, as representatively illustrated in FIG. 11B, is referred to as DB8.

Each recessed region 240 and 340 is covered with a corresponding fabric or leather overlay 290 and 390. The top cover fabric or leather overlay 290 is sized to match recessed region 240 so as to terminate at the proximate side 230 of the raised lip 228 when adhesively coupled thereto. The overlay 290 has a thickness defined by a third dimension that is equal to or less than the first dimension, such that the outer surface of the overlay 290 resides at or below the raised surface 229 of the lip 228 at its perimeter extents bordering the proximate side 230 and is thus thereby protected by the border lip 228 from delaminating, fraying, or peeling away from the outer surface 221 of the supporting top panel 220 to which it is coupled. Similarly, the bottom cover fabric or leather overlay 390 is sized to match recessed region 340 so as to terminate at the proximate side 330 of the raised lip 328 when adhesively coupled thereto. The overlay 390 has a thickness defined by a fourth dimension that is equal to or less than the second dimension, such that the outer surface of the overlay 390 resides at or below the raised surface 329 of the lip 328 at its perimeter extents bordering the proximate side 330 and is thus thereby protected by the border lip 328 from delaminating, fraying, or peeling away from the outer surface 321 of the supporting bottom panel 320 to which it is adhesively coupled.

It should be understood that while the perimeter lips 228 and 328 are illustrated to extend along the entire perimeter of their corresponding panels 220 and 320, which provides an integrated border that is configured to mitigate against delaminating, fraying, or peeling of the overlays 290 and 390 on the entire periphery thereof, it is contemplated that the perimeter lips 228 and 328 may be configured to extend along only multiple portions or only along a majority of the perimeter edge regions of the corresponding panels 220 and 320. Hence, for example, it is contemplated that perimeter lips 228, 328 may extend along high impact zones, such as the corners, and not extend along other less likely impact regions, such as along the right and left sides. It should be further understood that the perimeter edge regions 223 and 323 and corresponding perimeter lips 228 and 328 may be also configured to provide greater protection in high impact regions of the cover, such as at the corners thereof. Thus, for example in the illustrated embodiments, as best illustrated in FIGS. 1D-1F, 2A-2D, 3A-3B, 9A, 9D-9F, 10A, 10C, and 10E, the rear covers of the bottom panel 320 includes a perimeter edge region 323 that wraps around from the sides to the face of the bottom panel 320, such that the perimeter lip 328 and the recessed region 340 adjacent thereto is positioned internally on the face of the panel 320, thereby protecting the overlay from direct rear side impacts and wear and tear. Such a wrap-around configuration of the perimeter edge region may be employed throughout either the top or bottom panels 220 and 320 or in high impact regions such as the corners, side regions. around user interface apertures, or even on support surfaces such as the regions around the support feet 380 and may extend sufficiently inward to form one or more or all of the support feet and thereby entirely replace one or more of the support feet 380.

The outer surfaces of the recessed regions 240 and 340 may be textured to facilitate better adhesion to the overlaid materials 290 and 390. For example, the recessed regions 240 and/or 340 may have an MT-1010 texture, whereas the other areas of the panels 220 and 320, including the display and keyboard compartments 225 and 325 and the retention tabs 227 and 327 may have a smooth finish (or un-textured surface), which will mitigate scratching of the laptop computer 10 or other mobile electronic device. Different textures in the recessed regions 240 and 340 may be used depending on the overlaid material and adhesive used.

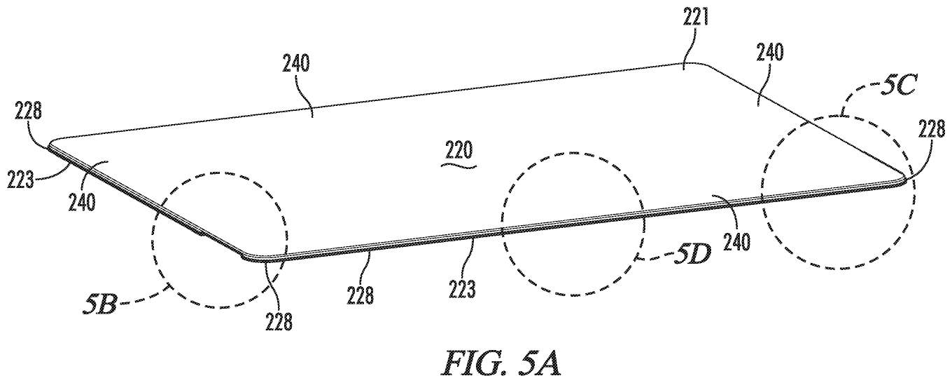

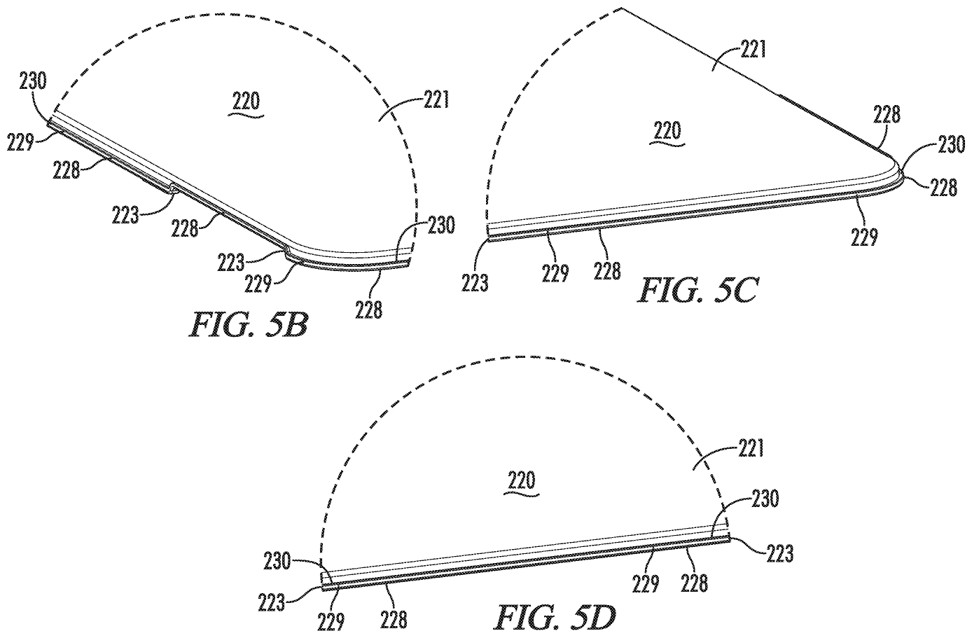

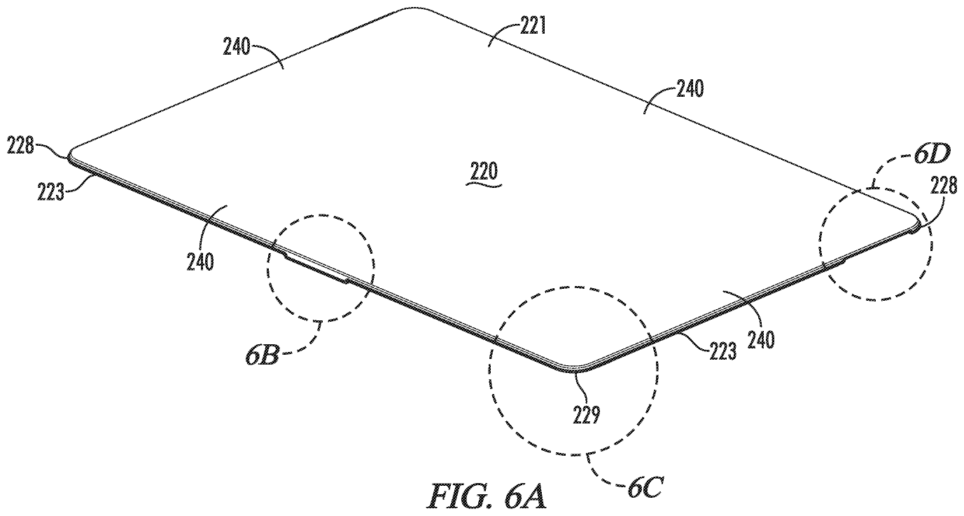

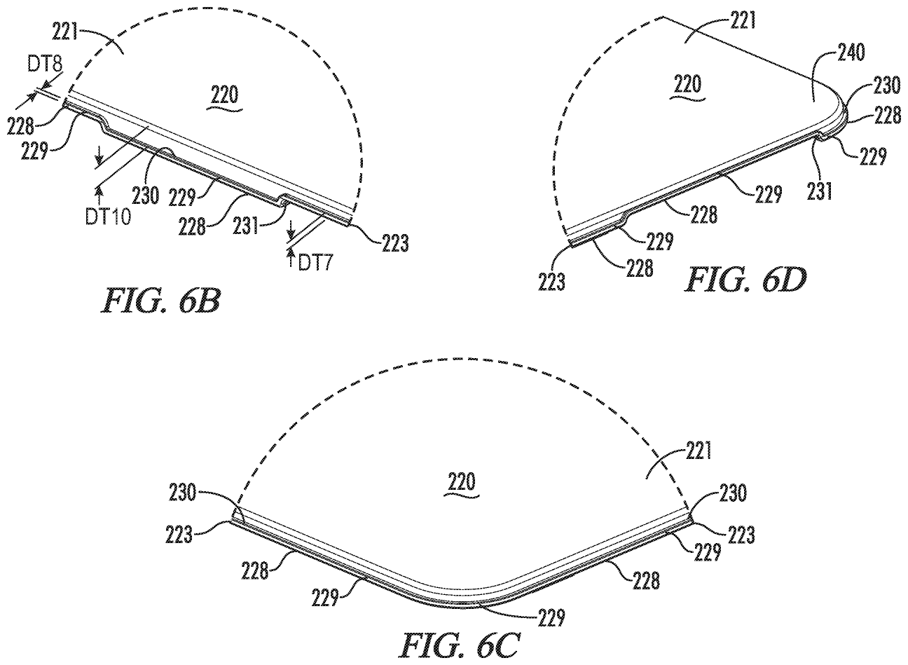

The overlays 290 and 390 may be made of any suitable organic or synthetic material including but not limited to woven or non-woven fabrics or textiles, leather, or combinations thereof. The top and bottom overlays 290 and 390 may be made of the same or different materials and may have the same or different thicknesses, equal to or less than the lip height dimensions DT8 (FIG. 6A, top panel 220) and DB8 (FIG. 1111, bottom panel). For example, it is contemplated that the top and bottom overlays 290 and 390 are formed of a single or multi-ply woven fabric that includes parallel grain lines that are oriented perpendicular to one another, and when coupled to the recessed regions 240 and 340, the grain lines are oriented to run parallel and perpendicular to the length and/or width of the cover. As another example, it is contemplated that the top and bottom overlays 290 and 390 are formed of fabrics having different thicknesses or designs. Thus, for example the bottom overlay 390 may be formed of a more durable thicker fabric than the top overlay 290, or alternatively may be formed of leather, and the top overlay 290 may be formed of a more delicate fabric or leather or a fabric with a different design, pattern, or color than the bottom. The bottom overlay 390 may for example be formed of a dark durable fabric or leather while the top overlay 290 may, for example, be formed of a lighter or less durable fabric or leather. While it is contemplated that the overlays 290 and 390 are each formed as unitary piece of fabric or leather, it should be understood that the overlays 290 and/or 390 may be formed of multiple pieces of fabrics and/or leather and adhered to the recessed regions on the panel as separate pieces or as a single component. It should also be understood that the fabric and/or leather overlays 290 and/or 390 may be formed of multiple plies of fabric and/or leather with or without a fabric or leather backing.

The bottom cover 300, in the illustrated embodiments, further includes a plurality of ventilation apertures 350 that extend through the bottom panel 320 and are positioned at the right and left side regions to correspond to ventilation holes in the laptop computer 10. The ventilation apertures 350 are defined by outwardly protruding ventilation aperture walls 355 that extend from the recessed region 340 of the outer surface 321 of the panel 320. The walls 355 include proximate and internal sides 360 and 361 that terminate at a raised surface 359. The proximate sides 360 of the walls 355 face outward from the ventilation apertures 350 toward the recessed region 340 whereas the internal side 361 defines the ventilation apertures 350. As measured on the proximate side 360 from the recessed region 340 extending outwardly from the base thereof to the raised surface 359, the aperture walls 355 have a height, which, as representatively illustrated in FIG. 11B, is referred to as DB9. The height of the aperture walls 355 on the left and right sides of the bottom cover panel 320 may be the same or different. As illustrated in the drawings, the overlay 390 has a thickness that is equal to or less than the height (DB39) of the aperture walls 355, such that the outer surface of the overlay 390, when coupled to the panel 320, resides at or below the raised surface 359 of the walls 355 at the overlay's perimeter extents bordering the proximate side 360 of the aperture walls 355. In this way, the overlay is protected by the raised surface 359 of the aperture walls 355 from delaminating, fraying, or peeling away from the outer surface 321 of the supporting bottom panel 320 to which it is adhesively coupled.

The bottom cover panel 320, as illustrated in the embodiments described herein, includes outwardly protruding footing platforms 370 at each corner. The platforms 370 are integrally molded as part of the unitary molded panel 321 and are defined on the inner surface 322 of the panel 320 by opposing recessed regions 371. The overlay 390, extends over the external or outer surface 321 of the panel 320, as illustrated in FIGS. 113-1F, 2C-2D, and 313 and the cross sections depicted in FIGS. 13B-13C and 16. A support foot 380 (best illustrated in FIG. 15) is coupled atop the overlay 390 to each of said footing platforms 370. Each support foot 380 is secured via an attachment hole 372 extending through the footing platform 370 to the corresponding recessed region 371 on the inner surface 322 of the bottom panel 320 opposite the protruding footing platform 371.

As illustrated in FIG. 15, the support foot 380 is dimensioned to include an internal portion 381 configured to reside on the interior surface 322 of recessed regions 371 and an external portion 382 configured to reside over the outwardly protruding tooting platforms 379 atop the overlay 390. The external and internal portions 382 and 381 are connected by a mid-region having a smaller annular diameter, where the external portion 382 has a larger diameter than both the internal portion 382 and the mid-region and where the internal portion 381 has a larger diameter than the mid-region of the support foot 380. The support foot 380 may be formed of any suitable material. For example, the support foot 380 may be formed as a unitary component made of molded thermoplastic polyurethane (TPU) that is sufficiently flexible and resilient to be manually deformed such that the internal portion 381 can be inserted through the support foot attachment hole 372 from the exterior of the cover 300 and, once inserted there-through, released, thereby allowing the internal portion 381 to resume its natural, unstressed shape.

The panels 220 and 320 are dimensioned and otherwise configured to correspond to the shape of the laptop computer for which the cover is adapted to be used. Since each electronic device model typically has unique dimensions and user interfaces, it is contemplated that the cover is uniquely dimensioned for the specific electronic device model. Thus, by way of example, the table below provides potentially suitable internal compartment dimensions and lip 228 and 328 dimensions (corresponding to the dimension lines set forth in FIGS. 4B, 6B, 9B, and 11B) of the top and bottom panels 220 and 320 for particular Apple MacBook laptop computers:

| | MacBook | | MacBook | | MacBook | | MacBook | |
|---|---|---|---|---|---|---|---|---|
| | 12 | | Air 13 | | Pro 13 | | Pro 15 | |
| DT1 | 284.4 | mm | 328.3 | mm | 307.8 | mm | 353.1 | mm |
| DT2 | 200.4 | mm | 230.6 | mm | 216.1 | mm | 244.2 | mm |
| DT7 | 1.0 | mm | 1.0 | mm | 1.0 | mm | 1.0 | mm |
| DT8 | 0.7 | mm | 0.7 | mm | 0.7 | mm | 0.7 | mm |
| DB1 | 284.4 | mm | 328.3 | mm | 307.8 | mm | 353.1 | mm |
| DB2 | 200.4 | mm | 230.6 | mm | 216.1 | mm | 244.2 | mm |
| DB3 | 242.0 | mm | 271.4 | mm | 258.9 | mm | 304.5 | mm |
| DB4 | 159.5 | mm | 173.8 | mm | 167.4 | mm | 194.9 | mm |
| DB5 | 221.0 | mm | 255.8 | mm | 239.8 | mm | 281.7 | mm |
| DB6 | 195.8 | mm | 223.1 | mm | 208.1 | mm | 236.6 | mm |
| DB7 | 1.0 | mm | 1.0 | mm | 1.0 | mm | 1.0 | mm |
| DB8 | 0.7 | mm | 0.7 | mm | 0.7 | nm | 0.7 | mm |
| DB9 | 0.7 | mm | 0.7 | mm | 0.7 | mm | 0.7 | mm |

The dimensions set forth in the foregoing table are in millimeters (mm). Although not specified in the table, the thickness of the bottom and top panels 220 and 320 may vary from 1.7 mm in the thicker perimeter edge regions 223 and 323 to 1 mm in the relatively more thin areas on the face of the panels and their corresponding recessed regions 240 and 340. The thickness of the fabric/cover overlays 290 and 390 is less than or equal to 0.7 mm, which is the height of the perimeter lips 228 and 328 (DT8, DB8) and the height of the ventilation aperture wall surface 359 (DB9).

It should be understood that while described herein are some examples of implementations with specific dimensions, measurements, and values, these dimensions are not intended to be exhaustive or to limit the invention to the precise form described. Moreover, the dimensional values provided are approximate values and may vary due to, for example, measurement or manufacturing variations or tolerances or other factors. For example, depending on the design and the manufacturing tolerances, the values may vary ±2 percent, ±5 percent. ±7 percent, or ±10 percent. Further, the dimensions are for a specific implementation, and other implementations may have different values, such as certain dimensions made larger for larger-sized electronic devices, or smaller for smaller-sized electronic devices. Internal cushions, inserts, or components may also be inserted into the compartment 225 and 325 of one or more of the panels 220 and 320 that may also result in one or more of the internal dimensions of the panel cover panels 220 and 320 being larger than the corresponding external dimension of the electronic device for which the panel is adapted for use.

It should also be understood that, as illustrated in the drawings, the top and bottom panels 220 and 320 may each include user access apertures that correspond to user interfaces 33 on the laptop computer 10 and facilitate easy access thereto by the user. The location and size of these apertures will correspond to the location and size of the user interfaces 33.

The top and bottom panels 220 and 320 may be formed of any suitable material. In some preferred embodiments, the panels are formed of materials selected fiom the group consisting of polycarbonate, fiber reinforced plastic, polypropylene, high density polyethylene, acrylic, thermoplastic polymer, and thermoset polymer. The panels are formed of different materials. The support foot may also be formed of any suitable material, including those previously set forth in connection with formation of the top and/or bottom panels 220 and 320. In some preferred embodiments, the support foot 380 is formed of a material that has greater elasticity and flexibility than the material that forms the bottom panel 320.

As set forth in more detail below and illustrated by the manufacturing process flow diagrams of FIGS. 14A-14B, the top and bottom panels 220 and 320 and the support feet 380 may each be manufactured as unitary structures by injection molding. The fabric/leather overlays are sized and then adhesively coupled to the recessed regions 240 and 340 on the exterior or outer surfaces 221 and 321 of the top and bottom panels 220 and 320 respectively and the feet 380 are attached to the bottom panel 320 through attachment holes 372.

More specifically, the flow diagrams of FIGS. 14A and 14B are directed to diagramming methods of manufacturing the protective cover 100, which is formed and dimensioned to reversibly and retentively receive and protect the laptop computer 10 having a display portion 20 and a keyboard portion 30. FIG. 14A is a flow diagram showing steps 400-416 for a process of manufacturing the top cover 200. FIG. 148 is a flow diagram showing steps 510-517 for a process of manufacturing the bottom cover 300. Similar steps in each process are described herein together.

### Formation and Preparation of Top and Bottom Panels

Steps 407 and 507 are directed to forming top and bottom panels 220 and 320 via injection molding. Steps 408 and 508 are directed to removing the respective top and bottom panels from their respective molds. Steps 409 and 509 are directed to deburring the respective top and bottom panels to remove any sharp edges or mold seepage.

The top and bottom panels 220 and 320 may be molded to include the various configurational aspects described above. Thus, by way of example, the top panel 220 is molded to include the opposing inner and outer surfaces 221 and 222 extending to the perimeter edge region 223 and is formed of a resilient flexible polymer material that is dimensioned to include the display portion compartment 225 defined by the inner surface 222 and reversibly and retentively snap-fit externally over the display portion 20. Similarly, the bottom panel 320 is molded to include the opposing inner and outer surfaces 321 and 322 extending to the perimeter edge region 323 and is formed of a resilient flexible polymer material that is dimensioned to include the keyboard portion compartment 325 defined by the inner surface 322 and reversibly and retentively snap-ft externally over the keyboard portion 30. Each of the top and bottom panels 220 and 320 is molded to include: (i) a plurality of retention tabs 227 or 327 extending inwardly from its inner surface 222 or 322 and positioned and dimensioned to retain the panel on the corresponding portion of the laptop 10, and (ii) an outwardly protruding wall structure extending longitudinally along the perimeter edge region 223 or 323 and projecting outwardly from the outer surface to define the raised perimeter lip 228 or 328 and adjacent recessed regions 240 or 340 on the respective panel's outer surface. The bottom panel 320 is molded to include (i) the ventilation apertures 350 defined by the aperture walls 355 and raised wall surface 359 and the outwardly protruding foot platforms 370 and corresponding opposing recessed regions 370.

### Formation of Support Feet

Steps 512 and 513 are directed to forming the support feet 380 for the bottom cover 300 via injection molding and removing the feet from the mold after molding to prepare for attaching the feet 380 to the bottom cover panel 320. Each foot 380 is molded to include an internal portion 381 and an external portion 382 that is connected by a mid-portion of less diameter as previously described. The foot is preferably molded of an elastic resilient material such as thermoplastic urethane. Other feet may also be employed, such as, for example, a two piece foot 380 where the external portion 382 and the internal portion 381 are formed separated from one another and then mechanically or adhesively coupled to the panel 320 directly or to each other when attached to the panel 320.

### Preparing Overlays and Adhesively Coupling them to the Recessed Regions of the Panels

Steps 401-406 and 501-506 generally detail the preparation of the fabric/leather overlay and Steps 410-411 and 414 and 510-511 and 515 detail the steps involved in adhesively coupling the fabric/leather to the corresponding panels 220 and 320.

Steps 401 and 501 are directed to preparing fabric or leather overlays 290 and 390 by applying a polyurethane coating to the inner surface of the overlay and allowing the coating to dry. The polyurethane coating may be of any suitable thickness, in some embodiments, the polyurethane coating is approximately 0.05 mm thick. The polyurethane coating bonds well to the overlay and facilitates improved adhesion by the adhesive to the polymer panels 220 and 320 as described below. In addition, the polyurethane coating may provide utility besides facilitating adhesion of the glue, such as providing the fabric overlay with stiffness, and may assist in, preventing the edges of the fabric from fraying. In some embodiments, the polyurethane coating may, depending on the nature and thickness of the coating, provide the fabric with a resilient and full appearance and serve as a cushion layer between the outer surface of the tfbric and the more rigid panel.

Steps 402 and 502 are directed to applying a heat-activated adhesive or glue coating over the polyurethane coating. In some embodiments, the heat-activated adhesive or glue has a thickness in the range of approximately 0.05 mm to 0.10 mm. With respect to steps 401. 402 and 501-502, the entire roll of fabric or leather material may be processed through an application machine that applies the polyurethane on the inner surface and then a heat activated adhesive or glue on top of the polyurethane coating.

Once the polyurethane and heat activated adhesive layers are applied over the inner side of the fabric or leather, as set forth in steps 403 and 503, the fabric or leather overlay is cut into an intermediate size (e.g., a smaller rectangular size) to facilitate manipulation and handling. Notably, steps 403 and 503 produce fabric or leather overlay constructs that am layered with polyurethane and heat activated adhesive and are oversized relative to the recessed areas 240 and 340 of the corresponding panels 220 and 320. Cutting after the polyurethane and heat activated glue is applied can help ensure that those layers extend al 1 the way to the edges of the cut fabric or leather overlay.

Once the fabric or leather overlay construct is initial cut (per steps 403 and 503), the overlay constructs are marked for register keys, which are holes in the fabric that are used to prevent movement of the overlay constructs and to ensure that the fabric is properly oriented.

### (Steps 404 and 504)

Steps 405 and key 505 are directed to punching the register holes in the overlay constructs. The register key holes are used for alignment and to orient the overlay construct at each, step, and to retain the position during the laser cutting and for silk screening logos on the exterior of the fabric/leather overlays.

Steps 406 and 506 are directed to cutting the fabric or leather overlay constructs so that they are sized to match the corresponding areas of the recessed regions 240 and 340 of the panels 220 and 320. The cutting may be performed by laser or any suitable mechanical means, for example, die cut. Laser cutting has been found to be highly accurate, and to provide excellent consistency and control. In addition, laser cutting results in a clean, seared edge of the overlay construct that can mate precisely and neatly against the proximate sides 230, 330, and 360 of the perimeter and ventilation walls. The laser cutting can also be automated with high speed and cutting throughput.

As set forth in steps 410-411 and 510-511, once the overlay constructs are cut to match the size of their corresponding recessed regions 240 and 340, the overlay constructs are respectively mated and adhered thereto so that their perimeter cut edges extend to the corresponding proximate side 230, 330, or 360 of the perimeter and ventilation walls of their respective panels 220 and 320. Thus, it is the heat activated adhesive layer or coating that comes into direct contact with and adheres to the recessed regions 240 and 340 of the panels 220 and 320. A heat plate may be used to heat activate the adhesive coating and exert pressure on the exterior surface of the overlay to ensure uniform adhesion to the recessed regions 240 and 340 of the panels 220 and 320. Initially the heat plate may be applied over the center region of the overlay and then along the side regions, thereby initially securing the overlay to the center or face regions of the panels 220 and 320 and then working outwards securing the overlays outward from the center to the perimeter edge regions of panel.

### Forming Foot Attachment Holes and Attaching Feet to Bottom Panel

Once the support feet 380 are formed in accordance with steps 512-513 and the fabric/leather overlay 390 is applied over the recessed region 340 of the outer surface 321 of the bottom panel 320, step 514 is directed to the foot attachment holes 372 being cut through the overlay 390 and the tooting platforms 370 of the bottom panel 320. A laser, or any suitable method of cutting, may be used to cut the foot attachment holes 372. The foot attachment holes 372 are cut after the fabric/leather overlay 390 is applied and adhered over and to the outer surface 321 of the outwardly protruding footing platforms 370. Once the foot attachment holes 372 are cut, as per step 515, additional heat pressing over the fabric/leather overlay 390 may be applied (to the extent needed), including around the foot attachment holes 372 and other regions of the panel 390, to ensure fil and complete adhesion of the overlay 390 to the outer surface 321 and recessed regions 340 of the panel 320. Because the foot attachment holes 372 are cut through both the panel 320 and the fabric overlay 390 at the same time, the cutting process is capable of ensuring that the foot attachment hole 372 in the bottom panel 320 is aligned and perfectly matched with the foot attachment hole 372 in the overlay 390. Once the foot attachment holes 372 are cut, a support, foot 380 is secured thereto per step 516. Each support foot 372, as previously described, is formed of a flexible elastic material capable of being stressed or distorted and yet having sufficient resiliency and elasticity to allow it to resume its original shape after the stress is removed. The support foot 380 is secured by sufficiently distorting the shape of the internal portion 381 and inserting it through the foot attachment hole 372 from the outside of the panel 320. This can be done manually or can be automated. Once inserted through the hole 372, the distortion pressure is removed and the internal portion 381 resumes its original shape and expands into position where it is retained and supported by the recessed region 371 on the internal surface 322 opposite the foot platform 370. Once the support foot 380 is secured, the peripheral regions of the external portion 382 resides externally over both the protruding footing platform 370 and the overlying fabric/leather overlay 390 with which it is in contact, thereby further protecting the fabric/leather overlay 390 from peeling, fraying, or delaminating. When other types of feet are employed, e.g., a two piece foot 380 where the external portion 382 and the internal portion 381 are formed separated from one another, the attachment process may be mechanical and/or via adhesive coupling directly to the panel 320 to opposing components 381 and 382 of the support foot 380 when the foot is attached to the panel 320.

Further it should be understood that while the bottom cover 300 includes footing platforms 370 and feet 380, the top cover 200 may be manufactured in the same manner to include footing platforms 370 and feet 380. Similarly, it should be understood that while the top cover does not include footing platforms 370 and feet 380, the bottom cover 300 may be manufactured in the same manner to exclude footing platforms 370 and feet 380. Also, while the ventilation holes 350 and corresponding wall structures are included in the bottom cover 300, it should be understood that the ventilation holes 350 may be manufactured in the top cover 200 to correspond with ventilation needs or structures in the display portion 20 of the electronic device 10. Thus, while particular manufacturing aspects are described as being part of the top or bottom covers 200 and 300, it should be understood that these manufacturing process include the configuration of components thereof that may be used with either the top or bottom cover alone or in combination.

Conditional language used herein, such as, among others, “can,” “might.” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising” “including,” “having.” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

While the above detailed description has shown, described, and pointed out novel features as applied to various embodiments, it will be understood that various omissions, substitutions, and changes in the form and details of the embodiments illustrated may be made without departing from the spirit of the disclosure. As will be recognized, certain embodiments of the inventions described herein may be embodied within a form that does not provide all of the features and benefits set forth herein, as some features may be used or practiced separately from others.

The previous description of the disclosed embodiments is provided to enable any person skilled in the art to make or use the invention disclosed herein. Although the various inventive aspects are disclosed in the context of certain illustrated embodiments, implementations, and examples, it should be understood by those skilled in the art that the invention extends beyond the specifically disclosed embodiments to other alternative embodiments and/or uses of the invention and obvious modifications and equivalents thereof. In addition, while a number of variations of various inventive aspects have been shown and described in detail, other modifications that are within their scope will be readily apparent to those skilled in the art based upon reviewing this disclosure. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Similarly, the disclosure is not to be interpreted as reflecting an intent that any claim set forth below requires more features than are expressly recited in that claim. Rather, as the following claims reflect, inventive aspects may reside in a combination of fewer than all features of any single foregoing disclosed embodiment.

Each of the foregoing and various aspects, together with those set forth in the claims and summarized above or otherwise disclosed herein, including the figures, may be combined without limitation to form claims for a device, apparatus, system, method of manufacture, and/or method of use.

All references cited herein are hereby expressly incorporated by reference.

What is claimed is:

1. A method of manufacturing a protective cover formed and dimensioned to reversibly and retentively receive and protect a laptop computer having a display portion and a keyboard portion, said method comprising:
molding a unitary first panel defined by opposing inner and outer surfaces extending to a perimeter edge region and formed of a resilient polymer material and dimensioned to include a display portion compartment defined by the inner surface and reversibly and retentively snap-fit over and cover the display portion;
molding a unitary second panel defined by opposing inner and outer surfaces extending to a perimeter edge region and formed of a resilient polymer material and dimensioned to include a keyboard compartment defined by the inner surface and reversibly and retentively snap-fit over the keyboard portion;
wherein each of said panels are molded to include:
(i) a plurality of retention tabs extending inwardly from the inner surface and positioned and dimensioned to retain the panel on the corresponding portion of the laptop,
(ii) an outwardly protruding wall structure extending longitudinally along the perimeter edge region and projecting outwardly from the outer surface to define a raised perimeter lip and an adjacent recessed region on the outer surface that is defined by said perimeter lip;
removing each of said panels from their respective molds;
deburring each panel as needed to remove any sharp edges;
preparing fabric overlays by holding the fabric in a fixed and taut position and laser cutting to size each fabric overlay to match corresponding recessed regions in the first and second panels; and
positioning and adhesively coupling the fabric overlays separately to each of the recessed regions with heat and pressure, wherein each fabric overlay has a total thickness that is less than or equal to the height of the raised perimeter lip of the panel to which it is adhesively coupled.

2. The method of claim 1, further comprising applying a polyurethane coating on the fabric overlays and then applying a heat activated adhesive over the polyurethane coating prior to positioning and adhesively coupling the fabric overlays.

3. The method of claim 1, further comprising applying a polyurethane coating on the fabric overlays and then applying a heat activated adhesive over the polyurethane coating prior to cutting to size each fabric overlay.

4. The method of claim 1, further comprising marking the fabric overlay and punching the fabric overlay with holes to assist in positioning the fabric overlay on the recessed region of the panel in the proper orientation.

5. The method of claim 1, wherein the unitary second panel is molded to include a plurality of ventilation apertures defined by a outwardly protruding raised walls that are internally positioned within the second panel, wherein said fabric overlay is sized to extend to the raised walls but not over the ventilation apertures, and wherein the thickness of the fabric overlay is less than or equal to the height of the raised walls.

6. The method of claim 1, wherein the unitary second panel is molded to include a plurality of outwardly protruding footing platforms and corresponding recessed regions on the inner surface of the second panel.

7. The method of claim 6, wherein the fabric overlay is adhesively coupled on top of said plurality of outwardly protruding footing platforms.

8. The method of claim 7, further comprising laser cutting foot attachment apertures into the fabric overlay and the underlying outwardly protruding footing platforms after the fabric overlay is adhesively coupled thereto.

9. The method of claim 8, further comprising heat pressing the fabric overlay on the unitary second panel around the foot attachment apertures and the outer perimeter regions of the fabric overlay as necessary to insure proper adhesion.

10. The method of claim 9, further comprising securing a support foot having an internal portion and external portion, wherein the support foot is secured by inserting the internal portion of the support foot through the foot attachment aperture and retentively supporting the internal surface by the recessed region on the inner surface of the second panel opposite the protruding footing platform, wherein once the support foot is secured, the external portion resides externally over both the protruding footing platform and the overlying fabric overlay.

11. The method of claim 10, wherein once the support foot is secured, the external portion resides in contact with the overlying fabric overlay.

12. A cover for a mobile electronic device comprising:
a relatively rigid but flexible unitary molded shell having an inner surface dimensioned to reversibly snap-fit externally over the electronic device and an opposing outer surface partitioned therefrom by a perimeter edge region that includes an outwardly protruding lip that encircles and defines a recessed region on the outer surface of the shell; and
a fabric overlay comprising a fabric outer layer, a polyurethane intermediate layer, and an inner adhesive coating, wherein said fabric overlay is adhesively coupled by its inner adhesive coating to said recessed region;
wherein the fabric overlay is sized to match said recessed region and the inner surface of the shell defines a compartment that corresponds in shape with the external surface of the electronic device, such that when the electronic device is retentively received within the shell at least the majority of the inner surface of the shell is in contact with the electronic device.
